(19) United States
(12) Patent Application Publication
(10) Pub. No.: US 2026/0175722 A1
(43) Pub. Date: Jun. 25, 2026

(54) POWER SUPPLY DEVICE

(71) Applicant: TATSUMI RYOKI CO., LTD, Tokyo (JP)

(72) Inventor: Toyoshi KONDO, Tokyo (JP)

(21) Appl. No.: 18/708,956

(22) PCT Filed: Jun. 17, 2022
(86) PCT No.: PCT/JP2022/024319

§ 371 Date: Mar. 7, 2026

(30) Foreign Application Priority Data
Jan. 20, 2022 (WO) PCT/JP2022/001933

(51) Int. Cl. B60L 53/30; B60L 50/40; B60L 53/14; B60L 58/20

(52) U.S. Cl. CPC B60L 53/30; B60L 50/40; B60L 53/14; B60L 58/20

(57) ABSTRACT

A power supply device includes: a power storage unit including a first power storage device and a second power storage device; and a first switch used, when a first condition is satisfied, to switch a power supply source to a first electric device between the first power storage device and the second power storage device in order to drive the first electric device for at least a first time. The first power storage device is capable of supplying power to a load and the first electric device. The second power storage device is capable of supplying power to the load and the first electric device. In a first use mode in which the power supply source to the first electric device is set to the first power storage device, until the first condition is satisfied, power supply from the first power storage device to the load and the first electric device and power supply from the second power storage device to the first electric device are restricted. In the first use mode, when the first condition is satisfied, the power supply from the first power storage device to the load is restricted, the power supply from the second power storage device to the first electric device is restricted, and the power supply from the first power storage device to the first electric device is performed.

### TECHNICAL FIELD

The present invention relates to a power supply device and the like.

### BACKGROUND ART

Conventionally, as disclosed in Patent Literature 1, there has been proposed a charging/discharging device for an electric vehicle that stores power and supplies the stored power to the electric vehicle or the like.

### CITATION LIST

### Patent Literature

Patent Literature 1: JP 2015-208132 A.

### SUMMARY OF INVENTION

### Technical Problem

However, charging/discharging control of a plurality of power storage devices is not considered.

Therefore, an object of the present invention is to provide a power supply device and the like capable of efficiently supplying power.

### Solution to Problem

A power supply device according to the present invention is a power supply device that supplies power to an external load and a first electric device different from the load.

The power supply device includes: a power storage unit including a first power storage device and a second power storage device; and a first switch used, when a first condition is satisfied, to switch a power supply source to the first electric device between the first power storage device and the second power storage device in order to drive the first electric device for at least a first time.

The first power storage device is capable of supplying the power to the load and the first electric device.

The second power storage device is capable of supplying the power to the load and the first electric device.

In a first use mode in which the power supply source to the first electric device is set to the first power storage device, until the first condition is satisfied, power supply from the first power storage device to the load and the first electric device and power supply from the second power storage device to the first electric device are restricted.

In the first use mode, when the first condition is satisfied, the power supply from the first power storage device to the load is restricted, the power supply from the second power storage device to the first electric device is restricted, and the power supply from the first power storage device to the first electric device is performed.

In a second use mode in which the power supply source to the first electric device is set to the second power storage device, until the first condition is satisfied, power supply from the second power storage device to the load and the first electric device and power supply from the first power storage device to the first electric device are restricted.

In the second use mode, when the first condition is satisfied, the power supply from the second power storage device to the load is restricted, the power supply from the first power storage device to the first electric device is restricted, and the power supply from the second power storage device to the first electric device is performed.

According to the use mode, restriction control of an object to which power is supplied from each of the power storage devices (the first power storage device and the second power storage device) is performed.

As a result, power for driving the first electric device for the first time can be constantly secured in one of the first power storage device and the second power storage device, and power can be supplied to a load different from the first electric device by using the other of the first power storage device and the second power storage device.

That is, a power supply device capable of efficiently supplying power can be configured.

Preferably, in the first use mode, when the first power storage device is capable of driving the first electric device for a time longer than the first time, restriction of the power supply from the first power storage device to the load is released until the first condition is satisfied.

In the second use mode, when the second power storage device is capable of driving the first electric device for a time longer than the first time, restriction of the power supply from the second power storage device to the load is released until the first condition is satisfied.

Accordingly, it is possible to supply surplus power to other loads while securing power that can be supplied to the first electric device.

Preferably, the power supply device supplies the power to the load, the first electric device, and a second electric device different from the load and the first electric device.

The power storage unit includes a third power storage device and a fourth power storage device.

The power supply device includes a second switch used, when a second condition is satisfied, to switch a power supply source to the second electric device between the third power storage device and the fourth power storage device in order to drive the second electric device for at least a second time.

The third power storage device is capable of supplying the power to the load and the second electric device.

The fourth power storage device is capable of supplying the power to the load and the second electric device.

In a third use mode in which the power supply source to the second electric device is set to the third power storage device, until the second condition is satisfied, power supply from the third power storage device to the load and the second electric device and power supply from the fourth power storage device to the second electric device are restricted.

In the third use mode, when the second condition is satisfied, the power supply from the third power storage device to the load is restricted, the power supply from the fourth power storage device to the second electric device is restricted, and the power supply from the third power storage device to the second electric device is performed.

In a fourth use mode in which the power supply source to the second electric device is set to the fourth power storage device, until the second condition is satisfied, power supply from the fourth power storage device to the load and the second electric device and power supply from the third power storage device to the second electric device are restricted.

In the fourth use mode, when the second condition is satisfied, the power supply from the fourth power storage device to the load is restricted, the power supply from the third power storage device to the second electric device is restricted, and the power supply from the fourth power storage device to the second electric device is performed.

According to the use mode, restriction control of a target to which power is supplied from each of the power storage devices (the first power storage device to the fourth power storage device) is performed.

As a result, power for driving the first electric device for the first time can be constantly secured in one of the first power storage device and the second power storage device, and power can be supplied to a load different from the first electric device by using the other of the first power storage device and the second power storage device.

In addition, power for driving the second electric device for the second time can be constantly secured in one of the third power storage device and the fourth power storage device, and power can be supplied to a load different from the second electric device by using the other of the third power storage device and the fourth power storage device.

That is, a power supply device capable of efficiently supplying power can be configured.

Further, preferably, in the first use mode, when the first power storage device is capable of driving the first electric device for a time longer than the first time, restriction of the power supply from the first power storage device to the load is released until the first condition is satisfied.

In the second use mode, when the second power storage device is capable of driving the first electric device for a time longer than the first time, restriction of the power supply from the second power storage device to the load is released until the first condition is satisfied.

In the third use mode, when the third power storage device is capable of driving the second electric device for a time longer than the second time, restriction of the power supply from the third power storage device to the load is released until the second condition is satisfied.

In the fourth use mode, when the fourth power storage device is capable of driving the second electric device for a time longer than the second time, restriction of the power supply from the fourth power storage device to the load is released until the second condition is satisfied.

Accordingly, it is possible to supply surplus power to the other load while securing power that can be supplied to the first electric device and the second electric device.

The power supply device includes a control unit configured to control at least the first switch and the second switch.

The power is supplied from either the second power storage device or the fourth power storage device to the control unit in the first use mode and in the third use mode.

The power is supplied from either the second power storage device or the third power storage device to the control unit in the first use mode and in the fourth use mode.

The power is supplied from either the first power storage device or the fourth power storage device to the control unit in the second use mode and in the third use mode.

The power is supplied from either the first power storage device or the third power storage device to the control unit in the second use mode and the fourth use mode.

As a result, the power storage device necessary for supplying the power necessary for driving the first electric device for the first time and the power storage device necessary for supplying the power necessary for driving the second electric device for the second time are preserved, and the power supply of the control unit can be performed using other power storage devices.

Preferably, in the first use mode and in the third use mode, a load test of a power generation device connected to at least one of the second power storage device and the fourth power storage device is performed using at least one of the second power storage device and the fourth power storage device.

In the first use mode and in the fourth use mode, a load test of a power generation device connected to at least one of the second power storage device and the third power storage device is performed using at least one of the second power storage device and the third power storage device.

In the second use mode and in the third use mode, a load test of a power generation device connected to at least one of the first power storage device and the fourth power storage device is performed using at least one of the first power storage device and the fourth power storage device.

In the second use mode and in the fourth use mode, a load test of a power generation device connected to at least one of the first power storage device and the third power storage device is performed using at least one of the first power storage device and the third power storage device.

As a result, the load test can be performed using the power storage device in which almost no power is stored.

### Advantageous Effects of Invention

As described above, according to the present invention, it is possible to provide a power supply device and the like capable of efficiently supplying power.

### BRIEF DESCRIPTION OF DRAWINGS

FIG. 1 is a main configuration diagram of a power supply system according to a first embodiment.

FIG. 2 is a detailed configuration diagram of the power supply system according to the first embodiment.

FIG. 3 is a wiring diagram of a switching unit according to the first embodiment.

FIG. 4 is a configuration diagram of the power supply system illustrating the 11th power supply state (third state) and the 21st storage state.

FIG. 5 is a wiring diagram of the switching unit illustrating the 11th power supply state to the 13th power supply state and the 21st storage state.

FIG. 6 is a configuration diagram of the power supply system illustrating the 12th power supply state (fourth state) and the 22nd storage state.

FIG. 7 is a configuration diagram of the power supply system illustrating the 13th power supply state (third state) and the 21st storage state.

FIG. 8 is a configuration diagram of the power supply system illustrating the 11th power supply state (third state) and the 23rd storage state.

FIG. 9 is a wiring diagram of the switching unit illustrating the 11th power supply state to the 13th power supply state and the 23rd storage state.

FIG. 10 is a configuration diagram of the power supply system illustrating the 11th power supply state (third state) and the 24th storage state.

FIG. 11 is a configuration diagram of the power supply system illustrating the 21st power supply state (first state) and the 11th storage state.

FIG. 12 is a wiring diagram of the switching unit illustrating the 21st power supply state (first state) and the 11th storage state to the 13th storage state.

FIG. 13 is a configuration diagram of the power supply system illustrating the 22nd power supply state (second state) and the 12th storage state.

FIG. 14 is a wiring diagram of the switching unit illustrating the 22nd power supply state (second state) and the 11th storage state to the 13th storage state.

FIG. 15 is a configuration diagram of the power supply system illustrating the 23rd power supply state (first state) and the 13th storage state.

FIG. 16 is a wiring diagram of the switching unit illustrating the 23rd power supply state (first state) and the 11th storage state to the 13th storage state.

FIG. 17 is a configuration diagram of the power supply system illustrating the 21st power supply state (first state) and the 14th storage state.

FIG. 18 is a wiring diagram of the switching unit illustrating a state in which power is supplied from a plurality of power sources to a load.

FIG. 19 is a configuration diagram of the power supply system in which a second conversion device is provided between an AC power supply unit and the switching unit, and a first conversion device is provided between the switching unit and the load.

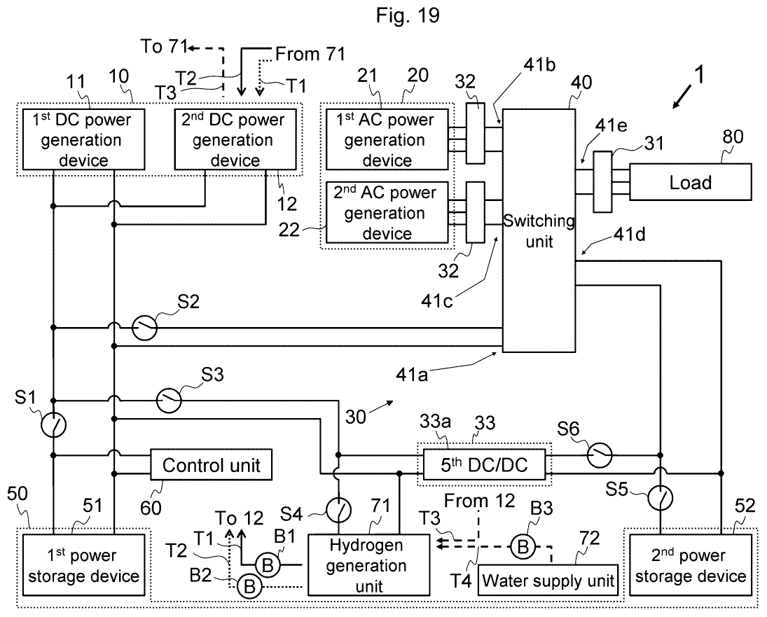

FIG. 20 is a configuration diagram of a power supply system according to a second embodiment.

FIG. 21 is a diagram illustrating a configuration of the 31st switch of the second embodiment.

### DESCRIPTION OF EMBODIMENTS

Hereinafter, a first embodiment will be described with reference to the drawings.

It is noted that the embodiment is not limited to the following embodiment. In addition, contents described in one embodiment are similarly applied to other embodiments in principle. Further, each embodiment and each modification can be appropriately combined.

### Power Supply System 1

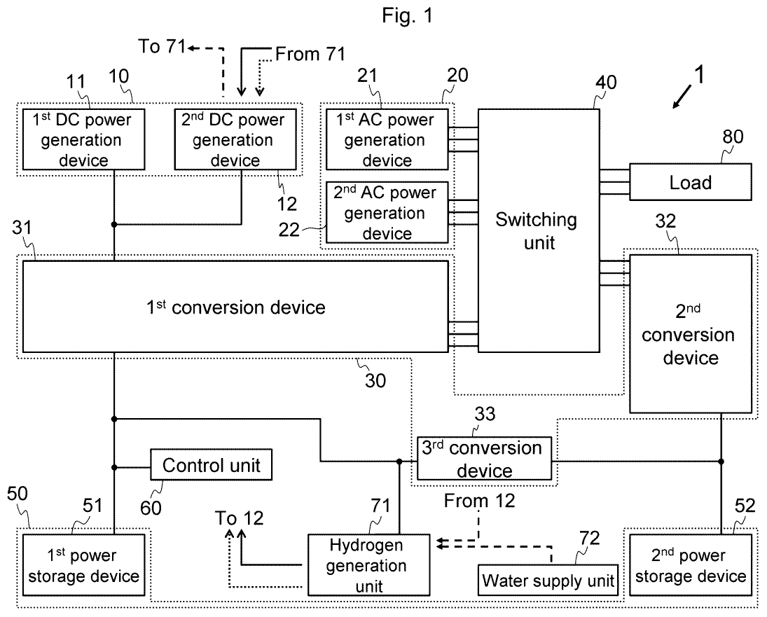

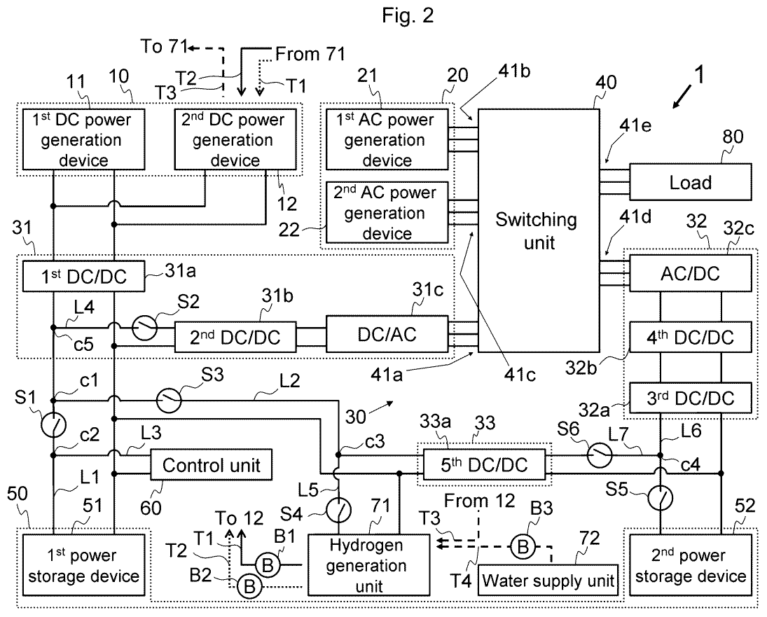

A power supply system 1 of a first embodiment includes a DC power supply unit 10, an AC power supply unit 20, a conversion unit 30, a switching unit 40, a power storage unit 50, a control unit 60, a hydrogen supply unit 70, switches (a first switch S1 to a sixth switch S6), and valves (a first valve B1 to a second valve B3) (refer to FIGS. 1 and 2).

The power supply system 1 generates power and supplies the generated power to a load 80. The load 80 is an electric device driven by AC power, such as an air conditioner.

### DC Power Supply Unit 10

The DC power supply unit 10 includes a first DC power generation device 11 and a second DC power generation device 12.

The first DC power generation device 11 is a power generation device (renewable energy-derived power generation device) that generates DC power based on natural energy (renewable energy), such as a solar power generation device.

The first DC power generation device 11 is constantly brought into a state of being capable of generating power.

The power obtained by the first DC power generation device 11 is supplied to a first power storage device 51 and the like via a first conversion device 31.

The first DC power generation device 11 includes a backflow prevention device such as a diode.

The second DC power generation device 12 is a power generation device (fuel cell) that generates power based on hydrogen.

The second DC power generation device 12 is brought into a state of being capable of generating power when power supplied from the first DC power generation device 11 or the like is not sufficient.

The power obtained by the second DC power generation device 12 is supplied to the first power storage device 51 and the like via the first conversion device 31.

The second DC power generation device 12 includes a backflow prevention device such as a diode.

### AC Power Supply Unit 20

The AC power supply unit 20 includes a first AC power generation device 21 and a second AC power generation device 22.

The first AC power generation device 21 is a power generation device (renewable energy-derived power generation device) that generates AC power based on natural energy (renewable energy), such as a wind power generation device and a wave power generation device.

The first AC power generation device 21 is constantly brought into a state of being capable of generating power.

However, in a case where the first AC power generation device 21 is a wind power generation device and wind force received by the first AC power generation device 21 exceeds a predetermined wind force, the first AC power generation device 21 is brought into a state in which power generation cannot be performed.

The power obtained by the first AC power generation device 21 is supplied to a second power storage device 52 and the like via the switching unit 40 and a second conversion device 32.

The second AC power generation device 22 is a power generation device that generates AC power based on kinetic energy obtained by an internal combustion engine or an external combustion engine, such as an LP gas power generation device.

The second AC power generation device 22 is brought into a state of being capable of generating power, for example, when the power supplied from the first AC power generation device 21 or the like is not sufficient.

The power obtained by the second AC power generation device 22 is supplied to the second power storage device 52 and the like via the switching unit 40 and the second conversion device 32.

### Conversion Unit 30

The conversion unit 30 includes the first conversion device 31, the second conversion device 32, and a third conversion device 33.

The first conversion device 31 includes a first DC/DC converter 31a, a second DC/DC converter 31b, and a first DC/AC inverter 31c.

The first DC/DC converter 31a converts, into a predetermined value, each of the voltage of the power obtained by the first DC power generation device 11 and the voltage of the power obtained by the second DC power generation device 12.

The second DC/DC converter 31b converts, into a predetermined value, each of the voltage of the power from the first DC/DC converter 31a and the voltage of the power from the first power storage device 51.

The first DC/AC inverter 31c converts a flow of electricity of the power from the second DC/DC converter 31b from direct current (DC) to alternating current (AC).

Therefore, the first DC/DC converter 31a of the first conversion device 31 converts the voltage of the power from the first DC power generation device 11 and the voltage of the power from the second DC power generation device 12 into voltages that can be stored in the first power storage device 51.

In addition, the first conversion device 31 converts a flow of electricity of each of the power from the first DC power generation device 11, the power from the second DC power generation device 12, and the power from the first power storage device 51 into AC usable in the load 80.

### Application Example of First DC/DC Converter 31a

In the first embodiment, an example in which the first DC/DC converter 31a is provided between the DC power supply unit 10 and the second DC/DC converter 31b will be described, but the first DC/DC converter 31a may be provided between the second DC/DC converter 31b and the first power storage device 51.

The first DC/DC converter 31a and the second DC/DC converter 31b may be configured to be integrated with each other.

The second conversion device 32 includes a third DC/DC converter 32a, a fourth DC/DC converter 32b, and an AC/DC converter 32c.

The third DC/DC converter 32a includes a step-up/step-down DC/DC converter.

The third DC/DC converter 32a converts the voltage of the power from the second power storage device 52 into a predetermined value.

The third DC/DC converter 32a converts the voltage of the power from the fourth DC/DC converter 32b into a predetermined value.

The fourth DC/DC converter 32b is a bidirectional DC/DC converter including an isolation transformer.

The fourth DC/DC converter 32b converts the voltage of the power from the third DC/DC converter 32a into a predetermined value.

The fourth DC/DC converter 32b converts the voltage of the power from the second AC/DC converter 32c into a predetermined value.

The AC/DC converter 32c includes a bidirectional AC/DC converter.

The AC/DC converter 32c converts a flow of electricity of the power from the fourth DC/DC converter 32b from DC to AC.

The AC/DC converter 32c converts a flow of electricity of the power from the switching unit 40 from AC to DC.

Therefore, the second conversion device 32 converts a flow of electricity of each of the power from the first AC power generation device 21 and the power from the second AC power generation device 22 into DC and converts a voltage thereof into a voltage that can be stored in the second power storage device 52.

In addition, the second conversion device 32 converts a flow of electricity of the power from the second power storage device 52 into AC usable in the load 80.

### Application Example of Third DC/DC Converter 32a

The third DC/DC converter 32a and the fourth DC/DC converter 32b may be configured to be integrated with each other.

The third conversion device 33 includes a fifth DC/DC converter 33a.

The fifth DC/DC converter 33a includes a step-up/step-down DC/DC converter.

The fifth DC/DC converter 33a converts, into a predetermined value, each of the voltage of the power from the first DC/DC converter 31a and the voltage of the power from the first power storage device 51.

The fifth DC/DC converter 33a converts the voltage of the power from the second power storage device 52 into a predetermined value.

Therefore, the third conversion device 33 converts the voltage of the power from the first DC power generation device 11 into a voltage that can be stored in the second power storage device 52.

Further, the third conversion device 33 converts the voltage of the power from second power storage device 52 into a voltage that can be stored in the first power storage device 51.

### Switching Unit 40

The switching unit 40 is connected to the first AC power generation device 21, the second AC power generation device 22, the first conversion device 31, the second conversion device 32, and the load 80.

The switching unit 40 switches a power supply source to the load 80 to any one of the first DC power generation device 11, the second DC power generation device 12, the first AC power generation device 21, the second AC power generation device 22, the first power storage device 51, and the second power storage device 52.

The switching unit 40 switches a power supply source to the second power storage device 52 (or a hydrogen generation unit 71) via the AC/DC converter 32c to any one of the first AC power generation device 21 and the second AC power generation device 22.

The switching control of the switching unit 40 is performed by the control unit 60.

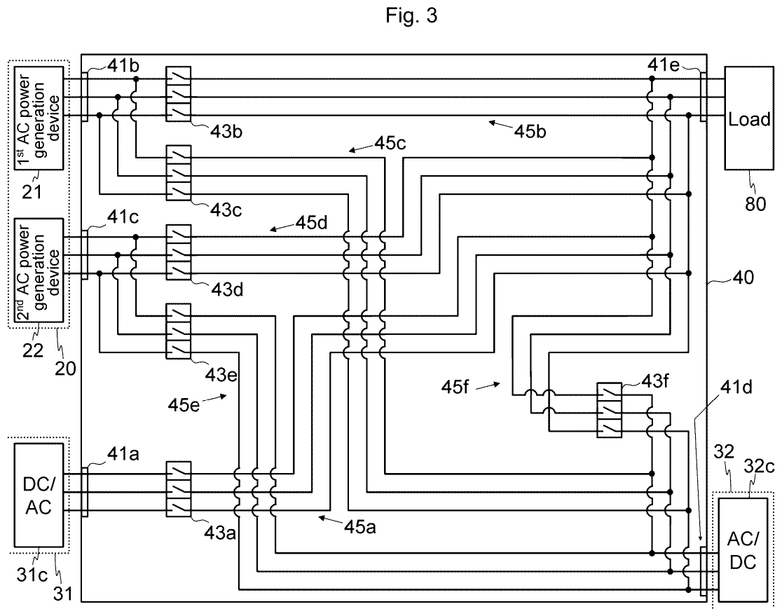

Specifically, the switching unit 40 includes a first port 41a to a fifth port 41e, first internal switches 43a to 43f, and a first internal power line 45a to a sixth internal power line 45f (refer to FIG. 3).

The first DC/AC inverter 31c is connected to the first port 41a.

That is, the first DC power generation device 11, the second DC power generation device 12, and the first power storage device 51 are connected to the first port 41a of the switching unit 40 via the first conversion device 31.

The first AC power generation device 21 is connected to the second port 41b.

The second AC power generation device 22 is connected to the third port 41c.

The AC/DC converter 32c is connected to the fourth port 41d.

That is, the second power storage device 52 is connected to the fourth port 41d of the switching unit 40 via the second conversion device 32.

The load 80 is connected to the fifth port 41e.

The first port 41a is connected to the fifth port 41e via the first internal power line 45a.

The second port 41b is connected to the fifth port 41e via the second internal power line 45b.

The second port 41b is connected to the fourth port 41d via the third internal power line 45c.

The third port 41c is connected to the fifth port 41e via the fourth internal power line 45d.

The third port 41c is connected to the fourth port 41d via the fifth internal power line 45e.

The fourth port 41d is connected to the fifth port 41e via the sixth internal power line 45f.

The first internal switch 43a is provided in the first internal power line 45a, and performs on/off switching of current flowing between the first port 41a and the fifth port 41e.

When the first internal switch 43a is turned on, power can be supplied from any one of the first DC power generation device 11, the second DC power generation device 12, and the first power storage device 51 to the load 80 via the first port 41a and the fifth port 41e.

The second internal switch 43b is provided in the second internal power line 45b, and performs on/off switching of current flowing between the second port 41b and the fifth port 41e.

When the second internal switch 43b is turned on, power can be supplied from the first AC power generation device 21 to the load 80 via the second port 41b and the fifth port 41e.

The third internal switch 43c is provided in the third internal power line 45c, and performs on/off switching of current flowing between the second port 41b and the fourth port 41d.

When the third internal switch 43c is turned on, power can be supplied from the first AC power generation device 21 to any one of the second power storage device 52 and the hydrogen generation unit 71 via the second port 41b and the fourth port 41d.

The fourth internal switch 43d is provided in the fourth internal power line 45d, and performs on/off switching of current flowing between the third port 41c and the fifth port 41e.

When the fourth internal switch 43d is turned on, power can be supplied from the second AC power generation device 22 to the load 80 via the third port 41c and the fifth port 41e.

The fifth internal switch 43e is provided in the fifth internal power line 45e, and performs on/off switching of current flowing between the third port 41c and the fourth port 41d.

When the fifth internal switch 43e is turned on, power can be supplied from the second AC power generation device 22 to any one of the second power storage device 52 and the hydrogen generation unit 71 via the third port 41c and the fourth port 41d.

The sixth internal switch 43f is provided in the sixth internal power line 45f, and performs on/off switching of current flowing between the fourth port 41d and the fifth port 41e.

When the sixth internal switch 43f is turned on, power can be supplied from the second power storage device 52 to the load 80 via the fourth port 41d and the fifth port 41e.

### Power Storage Unit 50

The power storage unit 50 includes the first power storage device 51 and the second power storage device 52 (refer to FIGS. 1 and 2).

The first power storage device 51 includes a charging device and a power storage device for storing power from the first DC power generation device 11 and the like.

The second power storage device 52 includes a charging device and a power storage device for storing power from the first AC power generation device 21 and the like.

### Control Unit 60

The control unit 60 controls each unit of the power supply system 1.

Specifically, the control unit 60 performs on/off control of the first internal switch 43a to the sixth internal switch 43f, on/off control of the first switch S1 to the sixth switch S6, opening/closing control of the first valve B1 to the third valve B3, and the like according to the state of each unit of the power supply system 1. Details of these controls will be described later.

The control unit 60 controls each unit so that charging and discharging are not simultaneously performed in the first power storage device 51 and charging and discharging are not simultaneously performed in the second power storage device 52.

When power storage in the first power storage device 51 is not performed, the control unit 60 is driven based on power supply from the first power storage device 51.

When power storage in the first power storage device 51 is performed, the control unit 60 is driven based on power supply from a power source (such as the first DC power generation device 11) that supplies power to the first power storage device 51.

However, the control unit 60 may be driven based on power supply from the second power storage device 52 or based on power supply from a power source (such as the first AC power generation device 21) that supplies power to the second power storage device 52.

### Hydrogen Supply Unit 70

The hydrogen supply unit 70 includes the hydrogen generation unit 71 and a water supply unit 72.

The hydrogen generation unit 71 performs electrolysis of an electrolytic solution such as water to generate hydrogen, stores the generated hydrogen in a hydrogen tank (not illustrated), generates oxygen, and stores the generated oxygen in an oxygen tank (not illustrated).

Water generated by the second DC power generation device 12 and supplied through a first electrolytic solution supply pipe T3 and water supplied from the water supply unit 72 through a second electrolytic solution supply pipe T4 are used as an electrolytic solution.

Hydrogen stored in the hydrogen tank of the hydrogen generation unit 71 is supplied to the second DC power generation device 12 through a hydrogen supply pipe T1.

The hydrogen supply pipe T1 allows a hydrogen discharge port of the hydrogen tank of the hydrogen generation unit 71 and a hydrogen introduction port of the second DC power generation device 12 to communicate with each other.

An oxygen supply pipe T2 allows an oxygen discharge port of the oxygen tank of the hydrogen generation unit 71 and an oxygen introduction port of the second DC power generation device 12 to communicate with each other.

The first electrolytic solution supply pipe T3 allows a water discharge port of the second DC power generation device 12 and an electrolytic solution introduction port of the hydrogen generation unit 71 to communicate with each other. However, in FIG. 1 and the like, an intermediate region between the hydrogen supply pipe T1, the oxygen supply pipe T2, and the first electrolytic solution supply pipe T3 is omitted.

Oxygen stored in the oxygen tank of the hydrogen generation unit 71 is supplied to the second DC power generation device 12 through the oxygen supply pipe T2.

The hydrogen tank of the hydrogen generation unit 71 stores hydrogen in a gaseous state, a liquefied state, a state of being occluded in a hydrogen storage alloy, a state of being changed to another compound such as an organic hydride, or the like.

The oxygen tank of the hydrogen generation unit 71 stores oxygen in a gaseous state, a liquefied state, or the like.

It is noted that oxygen generated in the hydrogen generation unit 71 may be discharged to the outside.

In this case, the second DC power generation device 12 takes in oxygen from the outside.

The water supply unit 72 supplies water taken in from the outside to the hydrogen generation unit 71 through the second electrolytic solution supply pipe T4.

### First Switch S1 to Sixth Switch S6

The first switch S1 to the sixth switch S6 are switched between an energized state and a non-energized state of each unit by switching an on/off state.

The first switch S1 is provided on a power line (a first power line L1) connecting the first DC/DC converter 31a to the first power storage device 51 between a connection point c1 with a power line (a second power line L2) extending from the fifth DC/DC converter 33a to the first power line L1 and a connection point c2 with a power line (a third power line L3) extending from the control unit 60 to the first power line L1.

The second switch S2 is provided on a power line (a fourth power line L4) connecting the first power line L1 to the second DC/DC converter 31b.

The third switch S3 is provided on the second power line L2 between the connection point c1 and a connection point c3 with a power line (a fifth power line L5) extending from the hydrogen generation unit 71 to the second power line L2.

The fourth switch S4 is provided on the fifth power line L5.

The fifth switch S5 is provided on a power line (a sixth power line L6) connecting the third DC/DC converter 32a to the second power storage device 52 between the second power storage device 52 and a connection point c4 with a power line (a seventh power line L7) extending from the fifth DC/DC converter 33a to the sixth power line L6.

The sixth switch S6 is provided on the seventh power line L7.

### Valve

The first valve B1 is provided on the hydrogen supply pipe T1, and adjusts the supply amount of hydrogen from the hydrogen tank of the hydrogen generation unit 71 to the second DC power generation device 12.

The second valve B2 is provided on the oxygen supply pipe T2, and adjusts the supply amount of oxygen from the oxygen tank of the hydrogen generation unit 71 to the second DC power generation device 12.

The third valve B3 is provided on the second electrolytic solution supply pipe T4, and adjusts the supply amount of electrolytic solution from the water supply unit 72 to the hydrogen generation unit 71.

### Connection of Each Unit

The first DC power generation device 11 and the second DC power generation device 12 are connected to the input side of the first DC/DC converter 31a.

The output side of the first DC/DC converter 31a is connected to the first power storage device 51 and the control unit 60 via the first switch S1.

The output side of the first DC/DC converter 31a is connected to the input side of the second DC/DC converter 31b via the second switch S2.

The output side of the first DC/DC converter 31a is connected to one of the input sides (the other of the output sides) of the fifth DC/DC converter 33a via the third switch S3.

The output side of the first DC/DC converter 31a is connected to the hydrogen generation unit 71 via the third switch S3 and the fourth switch S4.

The output side of the second DC/DC converter 31b is connected to the input side of the first DC/AC inverter 31c.

The output side of the first DC/AC inverter 31c is connected to the first port 41a of the switching unit 40.

One of the input sides (the other of the output sides) of the third DC/DC converter 32a is connected to the second power storage device 52 via the fifth switch S5.

One of the input sides (the other of the output sides) of the third DC/DC converter 32a is connected to the other of the input sides (the one of the output sides) of the fifth DC/DC converter 33a via the sixth switch S6.

One of the output sides (the other of the input sides) of the third DC/DC converter 32a is connected to one of the input sides (the other of the output sides) of the fourth DC/DC converter 32b.

One of the output sides (the other of the input sides) of the fourth DC/DC converter 32b is connected to one of the input sides (the other of the output sides, DC side) of the AC/DC converter 32c.

One of the output sides (the other of the input sides, AC side) of the AC/DC converter 32c is connected to the fourth port 41d of the switching unit 40.

### Control of Each Unit

Next, operation control of the control unit 60 will be described.

The control unit 60 performs power supply or the like to the load 80 in any one of a first mode and a second mode.

In the first mode, power is supplied to the load 80 using at least one of the first DC power generation device 11, the second DC power generation device 12, and the first power storage device 51.

Additionally, in the first mode, at least one of power storage by the second power storage device 52 and hydrogen generation by the hydrogen generation unit 71 is performed using at least one of the first AC power generation device 21 and the second AC power generation device 22.

In the second mode, power is supplied to the load 80 using at least one of the first AC power generation device 21, the second AC power generation device 22, and the second power storage device 52.

Additionally, in the second mode, at least one of power storage by the first power storage device 51 and hydrogen generation by the hydrogen generation unit 71 is performed using at least one of the first DC power generation device 11 and the second DC power generation device 12.

Details of the first mode will be described.

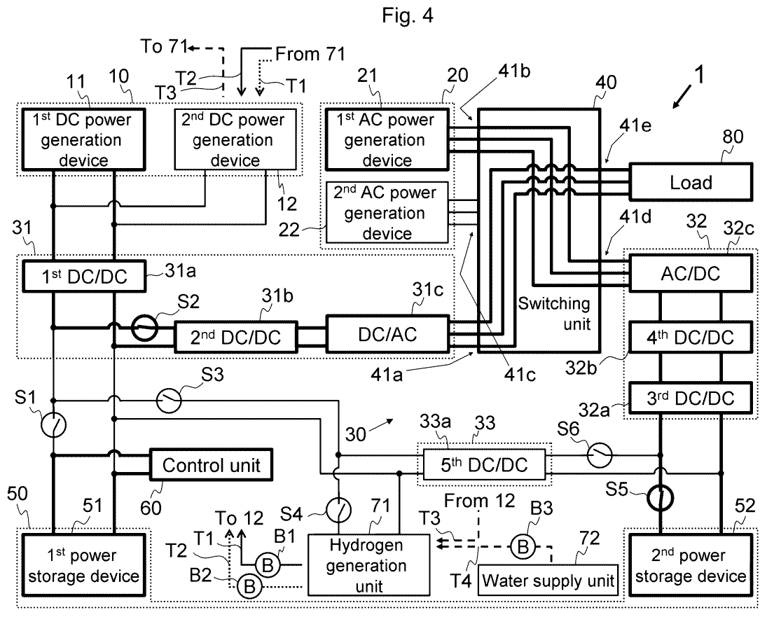

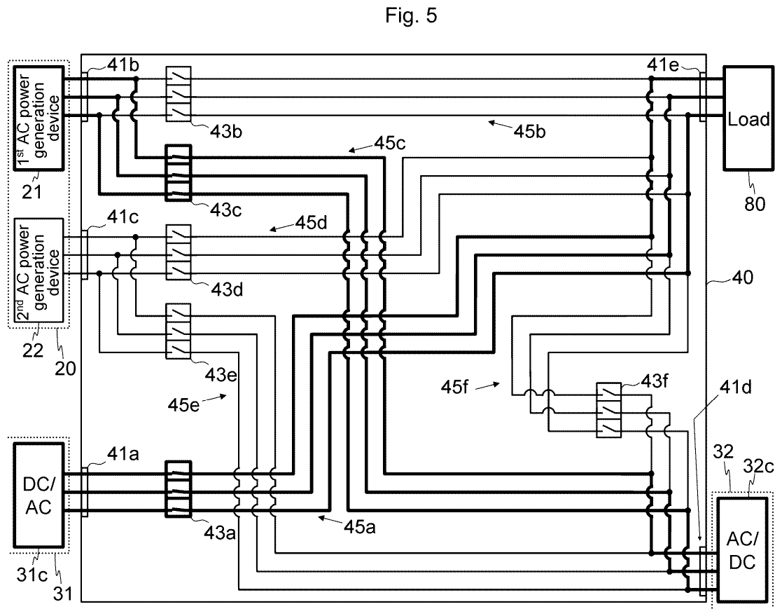

When power P11 supplied from the first DC power generation device 11 is greater than or equal to a first power threshold Thp1, the control unit 60 turns on the second switch S2, turns off the first switch S1 and the third switch S3, and controls the switching unit 40 so that power is supplied from the first DC power generation device 11 to the load 80 via the first DC/AC inverter 31c (11th power supply state (third state), refer to FIGS. 4 and 5).

Specifically, in the switching unit 40, the first internal switch 43a is turned on, and the second internal switch 43b, the fourth internal switch 43d, and the sixth internal switch 43f are turned off.

Power is supplied to the control unit 60 from the first power storage device 51.

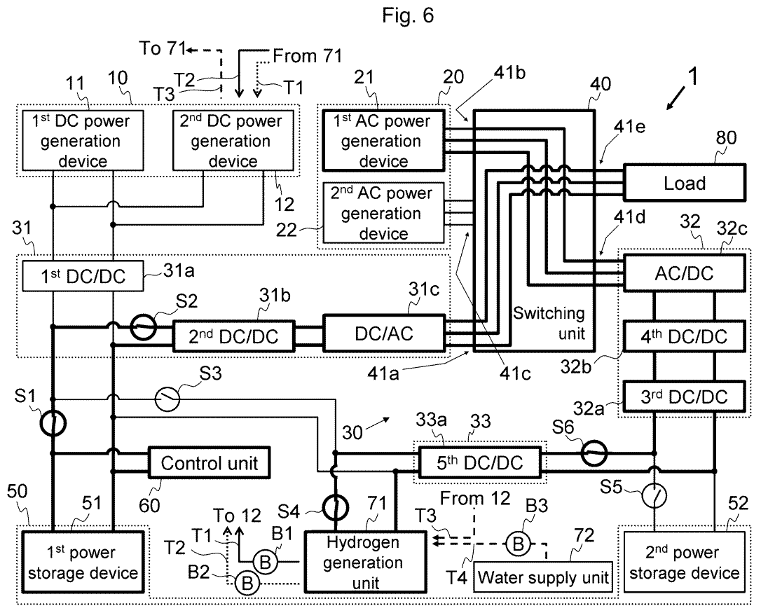

When the power P11 supplied from the first DC power generation device 11 is smaller than the first power threshold Thp1 and a charging rate R1 of the first power storage device 51 is higher than a first charging rate threshold Thr1, the control unit 650 turns on the first switch S1 and the second switch S2, turns off the third switch S3, and controls the switching unit 40 so that power is supplied from the first power storage device 51 to the load 80 via the first DC/AC inverter 31c (12th power supply state (fourth state), refer to FIG. 6).

Specifically, in the switching unit 40, the first internal switch 43a is turned on, and the second internal switch 43b, the fourth internal switch 43d, and the sixth internal switch 43f are turned off.

Power is supplied to the control unit 60 from the first power storage device 51.

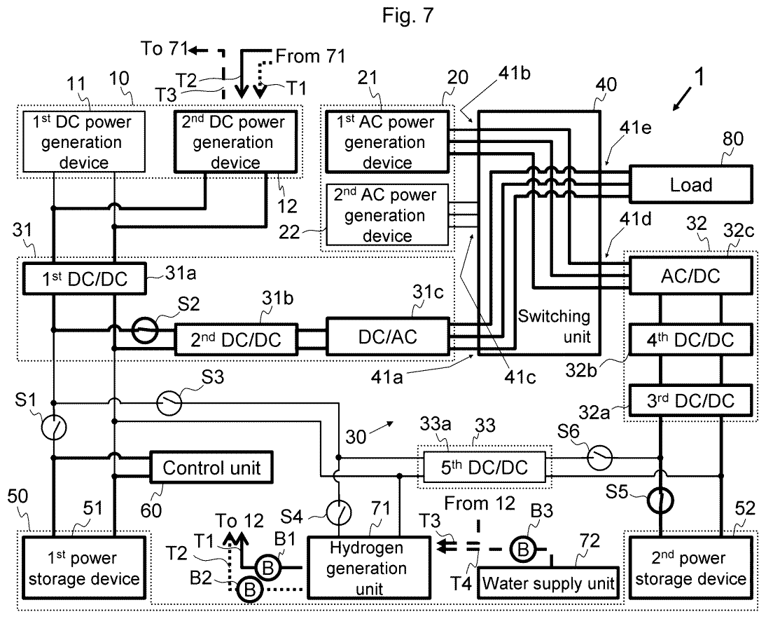

When the power P11 supplied from the first DC power generation device 11 is smaller than the first power threshold Thp1, the charging rate R1 of the first power storage device 51 is lower than the first charging rate threshold Thr1, and a hydrogen filling rate Rh of the tank of the hydrogen generation unit 71 is greater than or equal to a hydrogen filling rate threshold Thrh, the control unit 60 opens the first valve B1. Hydrogen is supplied from the hydrogen tank of the hydrogen generation unit 71 to the second DC power generation device 12 through the hydrogen supply pipe T1. In addition, the control unit 60 opens the second valve B2. Oxygen is supplied from the oxygen tank of the hydrogen generation unit 71 to the second DC power generation device 12 through the oxygen supply pipe T2. In addition, the control unit 60 controls the switching unit 40 so that the first switch S1 and the third switch S6 are turned off, the second switch S2 is turned on, and power is supplied from the second DC power generation device 12 to the load 80 via the first DC/AC inverter 31c (13th power supply state (third state), refer to FIG. 7).

Specifically, in the switching unit 40, the first internal switch 43a is turned on, and the second internal switch 43b, the fourth internal switch 43d, and the sixth internal switch 43f are turned off.

Power is supplied to the control unit 60 from the first power storage device 51.

Water generated by the second DC power generation device 12 is supplied to the hydrogen generation unit 71 through the first electrolytic solution supply pipe T3.

The control unit 60 also opens the third valve B3 in accordance with the amount of electrolytic solution in the hydrogen generation unit 71. The electrolytic solution is supplied from the water supply unit 72 to the hydrogen generation unit 71 through the second electrolytic solution supply pipe T4.

Under the 11th power supply state to the 13th power supply state, when power P21 supplied from the first AC power generation device 21 is greater than or equal to a second power threshold Thp2 and a charging rate (state of charge) R2 of the second power storage device 52 is lower than a second charging rate threshold Thr2, the control unit 60 turns on the fifth switch S5 and turns off the sixth switch S6, and controls the switching unit 40 so that power is supplied from the first AC power generation device 21 to the second power storage device 52 via the AC/DC converter 32c (21st storage state, refer to FIGS. 4 and 5).

Specifically, in the switching unit 40, the third internal switch 43c is turned on, and the fifth internal switch 43e is turned off.

Under the 11th power supply state to the 13th power supply state, when the power P21 supplied from the first AC power generation device 21 is greater than or equal to the second power threshold Thp2 and the charging rate R2 of the second power storage device 52 is higher than or equal to the second charging rate threshold Thr2, the control unit 60 turns on the fourth switch S4 and the sixth switch S6, turns off the fifth switch S5, and controls the switching unit 40 so that power is supplied from the first AC power generation device 21 to the hydrogen generation unit 71 via the AC/DC converter 32c (22nd storage state, refer to FIG. 6).

Specifically, in the switching unit 40, the third internal switch 43c is turned on, and the fifth internal switch 43e is turned off.

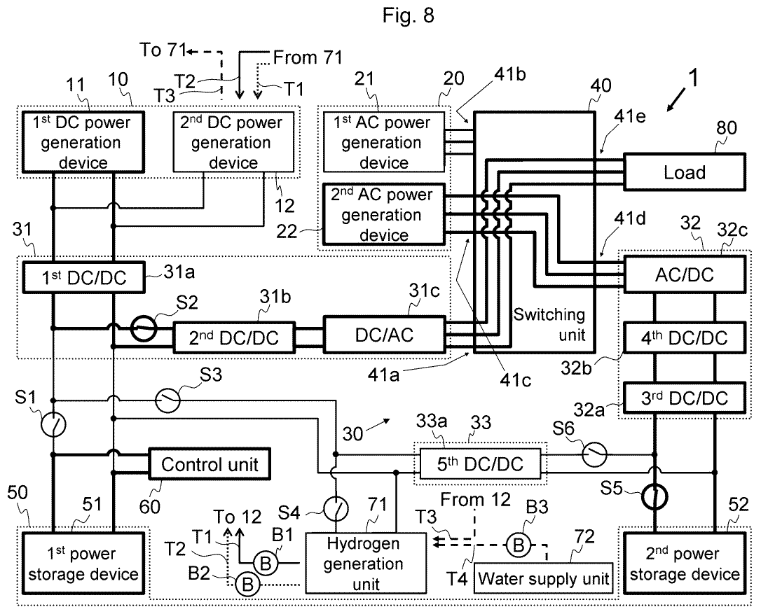

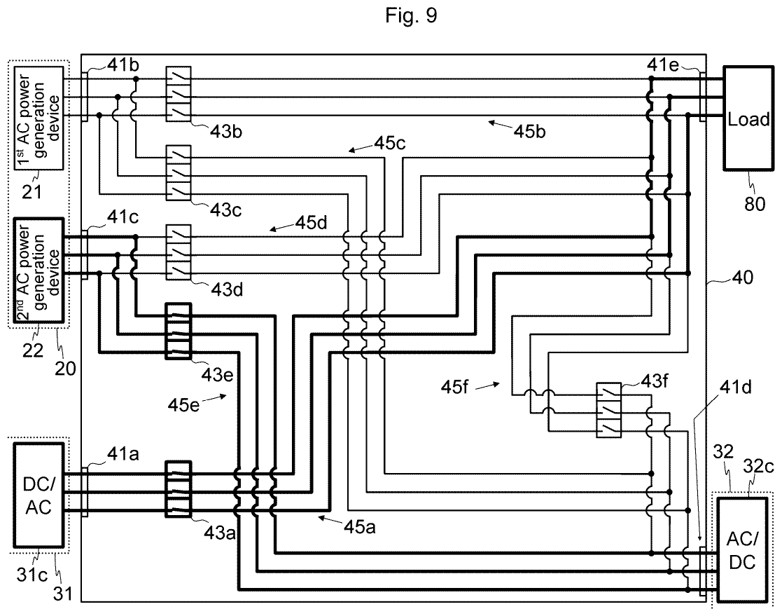

Under the 11th power supply state to the 13th power supply state, when the power P21 supplied from the first AC power generation device 21 is smaller than the second power threshold Thp2 and the charging rate R2 of the second power storage device 52 is lower than the second charging rate threshold Thr2, the control unit 60 controls the switching unit 40 so that the second AC power generation device 22 is turned on, the fifth switch S5 is turned on, the sixth switch S6 is turned off, and power is supplied from the second AC power generation device 22 to the second power storage device 52 via the AC/DC converter 32c (23rd storage state, refer to FIGS. 8 and 9).

Specifically, in the switching unit 40, the fifth internal switch 43e is turned on, and the third internal switch 43c is turned off.

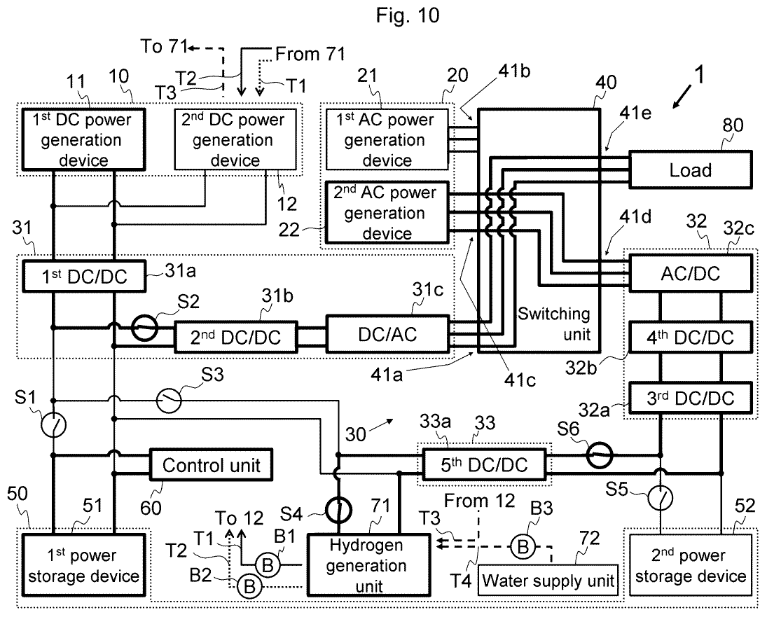

Under the 11th power supply state to the 13th power supply state, when the power P21 supplied from the first AC power generation device 21 is smaller than the second power threshold Thp2 and the charging rate R2 of the second power storage device 52 is higher than the second charging rate threshold Thr2, the control unit 60 turns on the second AC power generation device 22, turns on the fourth switch S4 and the sixth switch S6, and turns off the fifth switch S5 to control the switching unit 40 so s that power is supplied from the second AC power generation device 22 to the hydrogen generation unit 71 via the AC/DC converter 32c (24th storage state, refer to FIG. 10).

Specifically, in the switching unit 40, the fifth internal switch 43e is turned on, and the third internal switch 43c is turned off.

Details of the second mode will be described.

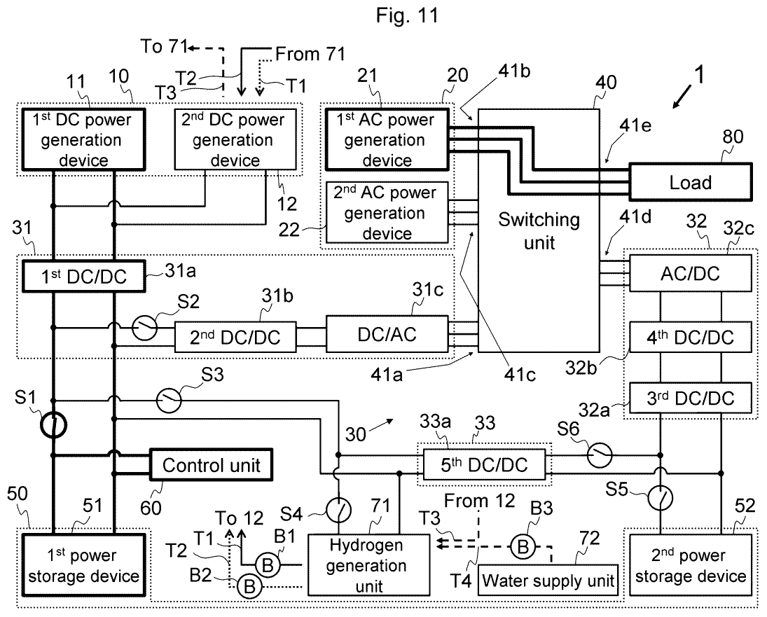

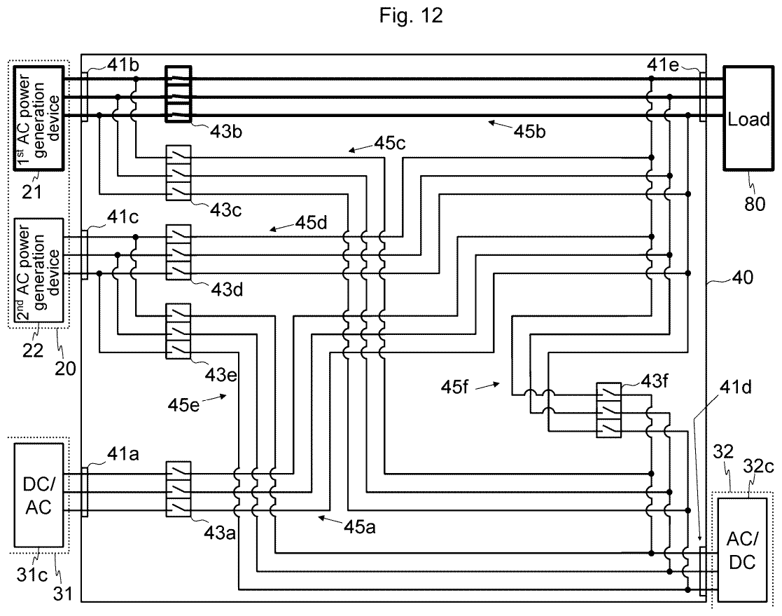

When the power P21 supplied from the first AC power generation device 21 is greater than or equal to the second power threshold Thp2, the control unit 60 turns off the fifth switch S5 and the sixth switch S6, and controls the switching unit 40 so that power is supplied from the first AC power generation device 21 to the load 80 (21st power supply state (first state), refer to FIGS. 11 and 12).

Specifically, in the switching unit 40, the second internal switch 43b is turned on, and the first internal switch 43a, the fourth internal switch 43d, and the sixth internal switch 43f are turned off.

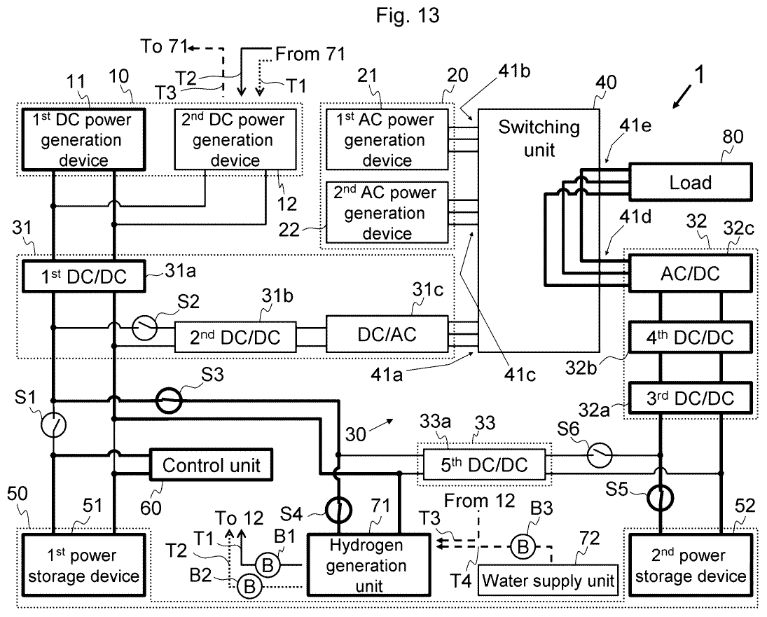

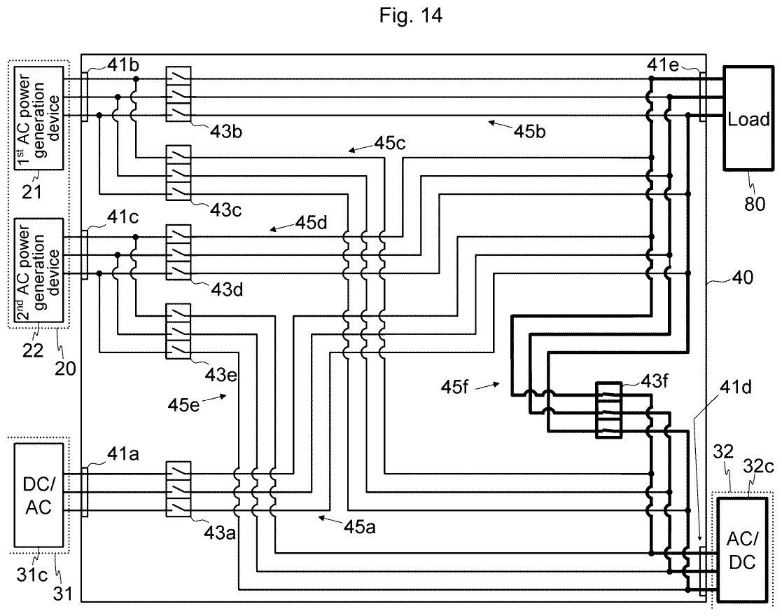

When the power P21 supplied from the first AC power generation device 21 is smaller than the second power threshold Thp2 and the charging rate R2 of the second power storage device 52 is higher than the second charging rate threshold Thr2, the control unit 60 turns on the fifth switch S5 and turns off the sixth switch S6, and controls the switching unit 40 so that power is supplied from the second power storage device 52 to the load 80 via the AC/DC converter 32c (22nd power supply state (second state), refer to FIGS. 13 and 14).

Specifically, in the switching unit 40, the sixth internal switch 43f is turned on, and the first internal switch 43a, the second internal switch 43b, and the fourth internal switch 43d are turned off.

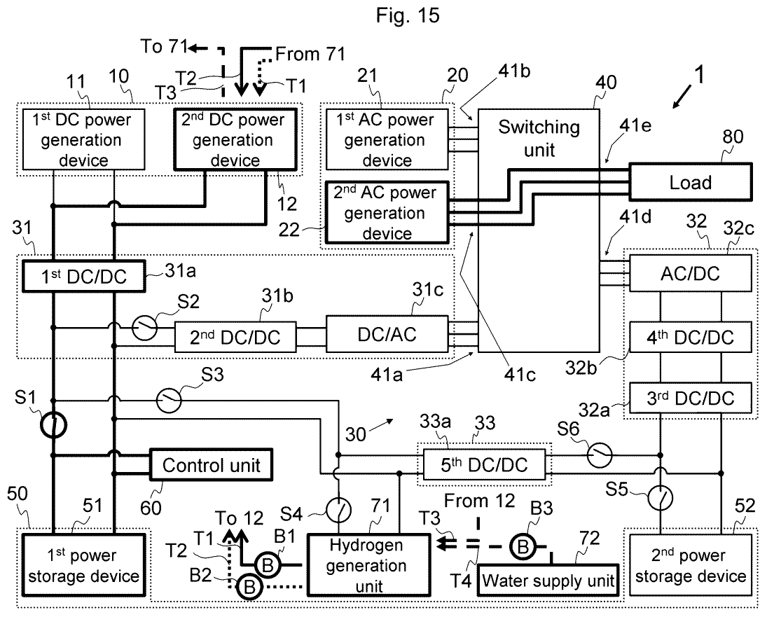

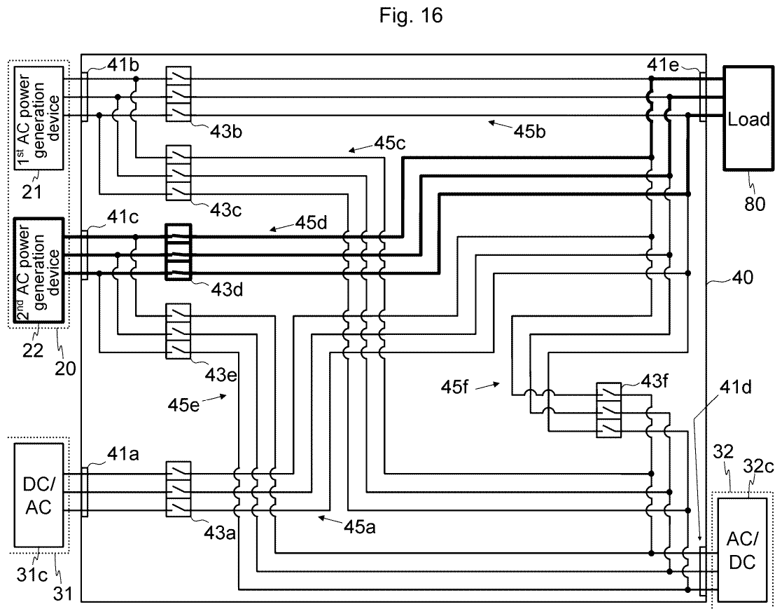

When the power P21 supplied from the first AC power generation device 21 is smaller than the second power threshold Thp2 and the charging rate R2 of the second power storage device 52 is smaller than the second charging rate threshold Thr2, the control unit 60 turns on the second AC power generation device 22, turns off the fifth switch S5 and the sixth switch S6, and controls the switching unit 40 so that power is supplied from the second AC power generation device 22 to the load 80 (23rd power supply state (first state), refer to FIGS. 15 and 16).

Specifically, in the switching unit 40, the fourth internal switch 43d is turned on, and the first internal switch 43a, the second internal switch 43b, and the sixth internal switch 43f are turned off.

Under the 21st power supply state to the 23rd power supply state, when the power P11 supplied from the first DC power generation device 11 is greater than or equal to the first power threshold Thp1 and the charging rate R1 of the first power storage device 51 is lower than the first charging rate threshold Thr1, the control unit 60 turns on the first switch S1 and turns off the second switch S2 and the third switch S3 so that power is supplied from the first DC power generation device 11 to the first power storage device 51 (11th storage state, refer to FIGS. 11 and 12).

Power is supplied to the control unit 60 from the first DC power generation device 11.

Under the 21st power supply state to the 23rd power supply state, when the power P11 supplied from the first DC power generation device 11 is greater than or equal to the first power threshold Thp1 and the charging rate R1 of the first power storage device 51 is higher than or equal to the first charging rate threshold Thr1, the control unit 60 turns on the third switch S3 and the fourth switch S4 and turns off the first switch S1 and the second switch S2 so that power is supplied from the first DC power generation device 11 to the hydrogen generation unit 71 (12th storage state, refer to FIGS. 13 and 14).

Power is supplied to the control unit 60 from the first power storage device 51.

Under the 21st power supply state to the 23rd power supply state, when the power P11 supplied from the first DC power generation device 11 is smaller than the first power threshold Thp1 and the charging rate R1 of the first power storage device 51 is lower than the first charging rate threshold Thr1, the control unit 60 opens the first valve B1. Hydrogen is supplied from the hydrogen tank of the hydrogen generation unit 71 to the second DC power generation device 12 through the hydrogen supply pipe T1. In addition, the control unit 60 opens the second valve B2. Oxygen is supplied from the oxygen tank of the hydrogen generation unit 71 to the second DC power generation device 12 through the oxygen supply pipe T2. The control unit 60 turns on the first switch S1 and turns off the second switch S2 and the third switch S3 so that power is supplied from the second DC power generation device 12 to the first power storage device 51 (13th storage state, refer to FIGS. 15 and 16).

Power is supplied to the control unit 60 from the first DC power generation device 11.

Water generated by the second DC power generation device 12 is supplied to the hydrogen generation unit 71 through the first electrolytic solution supply pipe T3.

The control unit 60 also opens the third valve B3 in accordance with the amount of electrolytic solution in the hydrogen generation unit 71. The electrolytic solution is supplied from the water supply unit 72 to the hydrogen generation unit 71 through the second electrolytic solution supply pipe T4.

### Mode Switching Control

The control unit 60 performs switching control between the first mode and the second mode.

For example, when the charging rate R1 of the first power storage device 51 becomes lower than a third charging rate threshold Thr3, the control unit 60 switches to the second mode (refer to FIGS. 11 to 16). The third charging rate threshold Thr3 is lower than the first charging rate threshold Thr1 (Thr3<Thr1).

When the charging rate R2 of the second power storage device 52 becomes lower than a fourth charging rate threshold Thr4, the control unit 60 switches to the first mode (refer to FIGS. 4 to 10). The fourth charging rate threshold Thr4 is lower than the second charging rate threshold Thr2 (Thr4<Thr2).

### Third Mode

Instead of the first mode, the control unit 60 may supply power to the load 80 in either the second mode or the third mode.

In the third mode, power is supplied to the load 80 using at least one of the first AC power generation device 21 and the second AC power generation device 22.

Further, in the third mode, the first power storage device 51 is used to store power in the second power storage device 52.

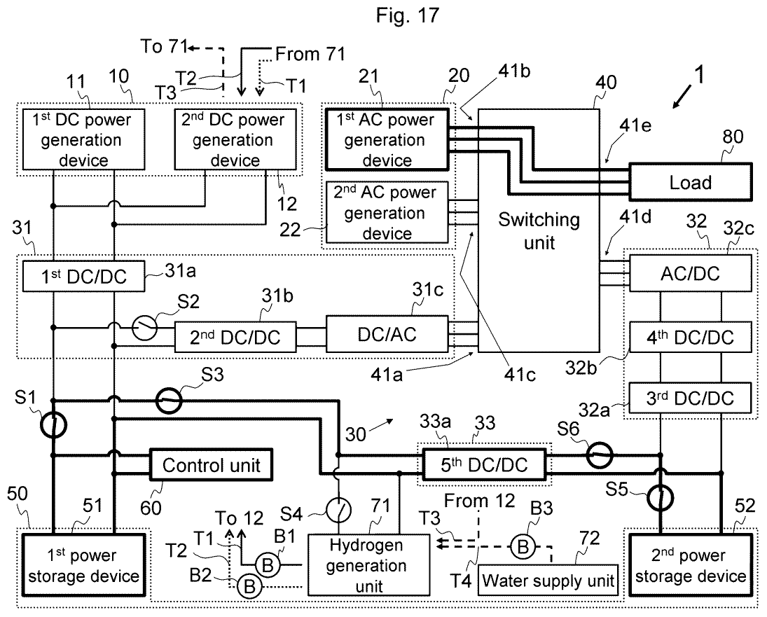

When the charging rate R2 of the second power storage device 52 becomes lower than the fourth charging rate threshold Thr4, the control unit 60 switches to the third mode (refer to FIG. 17).

Specifically, the control unit 60 turns on the first switch S1, the third switch S3, the fifth switch S5, and the sixth switch S6, turns off the second switch S2 and the fourth switch S4, and supplies power from the first power storage device 51 to the second power storage device 52 via the fifth DC/DC converter 33a (14th storage state).

Further, when the power P21 supplied from the first AC power generation device 21 is greater than or equal to the second power threshold Thp2, the control unit 60 controls the switching unit 40 so that power is supplied from the first AC power generation device 21 to the load 80.

Specifically, in the switching unit 40, the second internal switch 43b is turned on, and the first internal switch 43a, the fourth internal switch 43d, and the sixth internal switch 43f are turned off.

When the power P21 supplied from the first AC power generation device 21 is smaller than the second power threshold Thp2, the control unit 60 turns on the second AC power generation device 22 and controls the switching unit 40 so that power is supplied from the second AC power generation device 22 to the load 80.

Specifically, in the switching unit 40, the fourth internal switch 43d is turned on, and the first internal switch 43a, the second internal switch 43b, and the sixth internal switch 43f are turned off.

In the third mode, power is not supplied from the AC power supply unit 20 to the second power storage device 52. Therefore, the second conversion device 32 may perform only DC/AC conversion on the DC power from the second power storage device 52 without performing the AC/DC conversion on the AC power from the AC power supply unit 20.

### Application Example of Third Mode

In the third mode, power supply to the load 80 may be performed using at least one of the first DC power generation device 11 and the second DC power generation device 12.

In this case, a switch is provided on the first power line L1 between the first connection point c1 and a connection point c5 with the fourth power line L4. When power is supplied to the load 80 using at least one of the first DC power generation device 11 and the second DC power generation device 12, said switch is turned off.

### Application Example of First Conversion Device 31

In the first embodiment, an example in which the first conversion device 31 performs the DC/AC conversion on the DC power from the DC power supply unit 10 or the DC power from the first power storage device 51 has been mainly described.

However, the first conversion device 31 may further perform the AC/DC conversion on the AC power from the AC power supply unit 20.

In this case, the first DC/DC converter 31a includes a step-up/step-down DC/DC converter, the second DC/DC converter 31b includes a bidirectional DC/DC converter including an isolation transformer, and the first DC/AC inverter 31c includes a bidirectional AC/DC converter.

AC power from the AC power supply unit 20 can be converted into DC power by the first conversion device 31, and supplied to the first power storage device 51, the control unit 60, and the hydrogen generation unit 71.

### Application Example of Power Supply to Load 80

In the first embodiment, a description has been given as to an example in which power is supplied from any one of the first DC power generation device 11, the second DC power generation device 12, the first AC power generation device 21, the second AC power generation device 22, the first power storage device 51, and the second power storage device 52 to the load 80.

However, the power supply to the load 80 may be simultaneously performed from a plurality of the first DC power generation device 11, the second DC power generation device 12, the first AC power generation device 21, the second AC power generation device 22, the first power storage device 51, and the second power storage device 52.

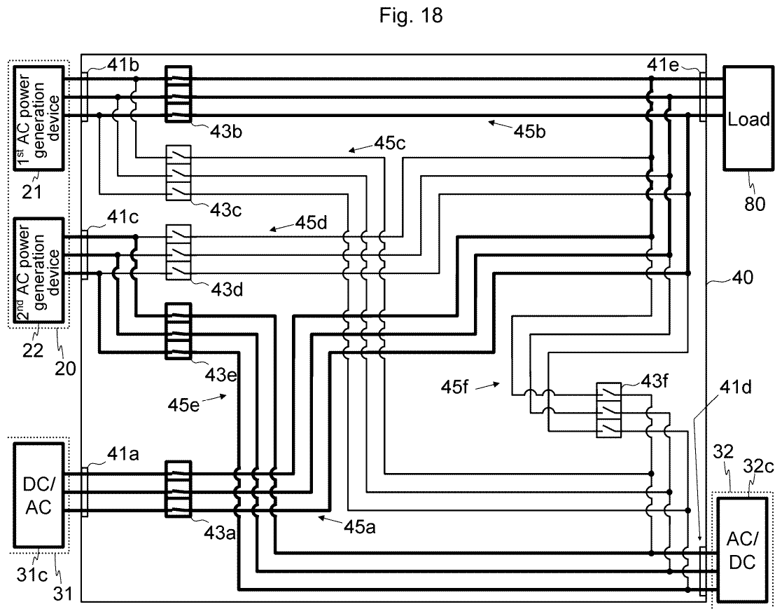

For example, when the first internal switch 43a, the second internal switch 43b, and the fifth internal switch 43e are turned on, power can be supplied from the first AC power generation device 21 and any one of the first DC power generation device 11, the second DC power generation device 12, and the first power storage device 51 to the load 80, and power can be supplied from the second AC power generation device 22 to the second power storage device 52 (refer to FIG. 18).

### Application Example of Arrangement of First Conversion Device 31 and Second Conversion Device 32

In the first embodiment, a description has been given as to an example in which the first conversion device 31 is provided between the DC power supply unit 10 and the switching unit 40, and the second conversion device 32 is provided between the switching unit 40 and the second power storage device 52.

However, the first conversion device 31 may be provided between the switching unit 40 and the load 80, and the second conversion device 32 may be provided in the AC power supply unit 20 and the switching unit 40. In this case, DC power flows through a power line (such as the first internal power line 45a) inside the switching unit 40.

### Effect of Controlling Power Supply to Power Storage Device in First Mode/Second Mode

When the first power storage device 51 is charged, power is supplied to the load using another power source (such as the second power storage device 52). When the second power storage device 52 is charged, power is supplied to the load using another power source (such as the first power storage device 51). Therefore, it is possible to simultaneously store one power of the first power storage device 51 and the second power storage device 52 and discharge the other power, and it is possible to efficiently maintain power supply from the power supply system 1 to the load 80 for a long time by using some of the power sources (the first power storage device 51 and the like) of the power supply system 1.

### Effect of Using Bidirectional AC/DC Converter 32c

AC/DC conversion of power from the AC power supply unit 20 and DC/AC conversion from the second power storage device 52 can be performed using one conversion device (the second conversion device 32).

### Effects of Controlling Power Supply to Power Storage Device in Second Mode/Third Mode

When the first power storage device 51 is charged, power is supplied to the load using another power source (such as the second power storage device 52). When the second power storage device 52 is charged, power is supplied to the load using another power source (such as the first power storage device 51). Therefore, it is possible to simultaneously store one power of the first power storage device 51 and the second power storage device 52 and discharge the other power, and it is possible to efficiently maintain power supply from the power supply system 1 to the load 80 for a long time by using some of the power sources (the first power storage device 51 and the like) of the power supply system 1.

Further, the DC power supply unit 10 is mainly used to supply power to the load 80 and the first power storage device 51, the AC power supply unit 20 is mainly used to supply power to the load 80, the first power storage device 51 is mainly used to supply power to the load 80 and the second power storage device 52, and the second power storage device 52 is mainly used to supply power to the load 80. That is, power supply to the power storage device is performed from a power source (such as a DC power supply unit) that generates DC power. Therefore, it is possible to reduce the loss in converting the flow of electricity of the power from AC to DC at the time of power storage.

### Effects of Using First DC Power Generation Device 11, Second DC Power Generation Device 12, and Hydrogen Generation Unit 71

By using the first DC power generation device 11 and the hydrogen generation unit 71, DC power can be stored in the first power storage device 51 based on natural energy, hydrogen can be generated, and said hydrogen can be stored.

By using the hydrogen generation unit 71 and the second DC power generation device 12, it is possible to store DC power in the first power storage device 51 based on hydrogen in a time zone in which the first power storage device 51 cannot sufficiently generate power or the like.

Hydrogen obtained by the hydrogen generation unit 71 is utilized by the second DC power generation device 12, whereby power generation can be maintained by the second DC power generation device 12.

By utilizing water obtained by the second DC power generation device 12 as an electrolytic solution in the hydrogen generation unit 71, hydrogen generation can be maintained in the hydrogen generation unit 71 even when the amount of water taken in from the outside is small.

### Effect of Using Oxygen Obtained by Hydrogen Generation Unit 71

By utilizing oxygen obtained by the hydrogen generation unit 71 in the second DC power generation device 12, power generation can be maintained by the second DC power generation device 12 even when the amount of oxygen taken in from the outside is small.

### Effect of Controlling Power Supply Source to Control Unit 60

By utilizing oxygen obtained by the hydrogen generation unit 71 in the second DC power generation device 12, power generation can be maintained by the second DC power generation device 12 even when the amount of oxygen taken in from the outside is small.

### Effects of Using First AC Power Generation Device 21 and Second AC Power Generation Device 22

By using the first AC power generation device 21, AC power can be supplied to the load 80 based on natural energy.

By using the second AC power generation device 22, even when power supply from the DC power supply unit 10, the first AC power generation device 21, the first power storage device 51, and the second power storage device 52 to the load 80 cannot be performed, power supply to the load 80 can be maintained.

### Power Supply System 1

Next, a second embodiment will be described.

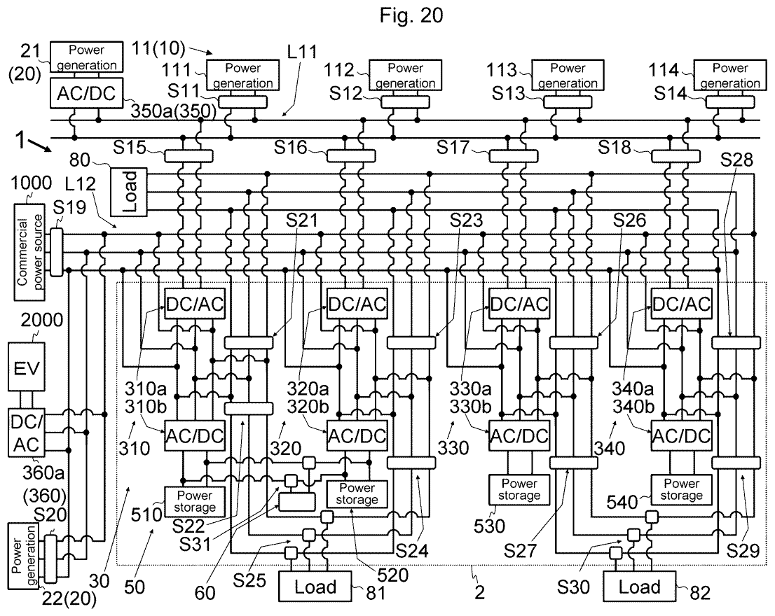

A power supply system 1 of the second embodiment includes the DC power supply unit 10, the AC power supply unit 20, the conversion unit 30, the power storage unit 50, the control unit 60, and switches (11th switch S11 to 31st switch S31) (refer to FIG. 20).

### Comparison with Claim Terms

An 11th power storage device 510, a 12th power storage device 520, a 13th power storage device 530, and a 14th power storage device 540 of the second embodiment correspond to a first power storage device, a second power storage device, a third power storage device, and a fourth power storage device, respectively, in the claims.

The 25th switch S25 and the 30th switch S30 of the second embodiment correspond to a first switch and a second switch, respectively, in the claims.

The DC power supply unit 10, the AC power supply unit 20, and an electric vehicle 2000 according to the second embodiment correspond to a power generation device in the claims.

A device (power supply device 2) including at least the power storage unit 50, the control unit 60, and a part of the switches (25th switch S25 and 30th switch S30) in the power supply system 1 according to the second embodiment corresponds to a power supply device in the claims (refer to a dotted frame in FIG. 20).

The power supply system 1 generates power, and supplies the generated power to the load 80, a first electric device 81, and a second electric device 82.

The load 80 is an electric device driven by AC power, such as an air conditioner.

The first electric device 81 is an electric device, such as an emergency light (emergency lighting fixture), which is not normally used, but is driven for at least a first time Ti1 (for example, Ti1=30 min) when a first condition is satisfied.

The second electric device 82 is an electric device, such as an emergency elevator, which is not normally used, but is driven for at least a second time Ti2 (for example, Ti2=60 min) when a second condition is satisfied.

A state in which the first condition is satisfied is, for example, a state in which power supply from a commercial power source 1000 is interrupted due to a power failure or the like.

A state in which the second condition is satisfied is, for example, a state in which a normal elevator of a building including the power supply system 1 cannot be used due to a fire or the like.

### DC Power Supply Unit 10

The DC power supply unit 10 includes the first DC power generation device 11.

However, the DC power supply unit 10 may include the second DC power generation device 12.

The first DC power generation device 11 is a power generation device (renewable energy-derived power generation device) that generates DC power based on natural energy (renewable energy), such as a solar power generation device.

The first DC power generation device 11 is constantly in a state of being capable of generating power.

The power obtained by the first DC power generation device 11 is supplied to the 11th power storage device 510 and the like via an 11th conversion device 310 and the like.

The first DC power generation device 11 includes a backflow prevention device such as a diode.

In the second embodiment, the first DC power generation device 11 includes four power generation devices (an 11th DC power generation unit 111, a 12th DC power generation unit 112, a 13th DC power generation unit 113, and a 14th DC power generation unit 114). However, the number of DC power generation units is not limited to four.

### AC Power Supply Unit 20

The AC power supply unit 20 includes a first AC power generation device 21 and a second AC power generation device 22.

The first AC power generation device 21 is a power generation device (renewable energy-derived power generation device) that generates AC power based on natural energy (renewable energy), such as a wind power generation device and a wave power generation device.

The first AC power generation device 21 is constantly in a state of being capable of generating power.

However, in a case where the first AC power generation device 21 is a wind power generation device and wind force received by the first AC power generation device 21 exceeds a predetermined wind force, the first AC power generation device 21 is brought into a state in which power generation cannot be performed.

The power obtained by the first AC power generation device 21 is supplied to the 11th power storage device 510 and the like via the 11th conversion device 310 and the like.

The second AC power generation device 22 is a power generation device that generates AC power based on kinetic energy obtained by an internal combustion engine or an external combustion engine, such as an LP gas power generation device.

The second AC power generation device 22 is brought into a state of being capable of generating power, for example, when the power supplied from the first AC power generation device 21 or the like is not sufficient.

The power obtained by the second AC power generation device 22 is supplied to the 11th power storage device 510 and the like via the 11th conversion device 310 and the like.

### Conversion Unit 30

The conversion unit 30 includes the 11th conversion device 310, a 12th conversion device 320, a 13th conversion device 330, a 14th conversion device 340, a 15th conversion device 350, and a 16th conversion device 360.

The 11th conversion device 310 includes an 11th DC/AC inverter 310a and an 11th AC/DC converter 310b.

The 11th DC/AC inverter 310a converts a flow of electricity of power from the 11th DC power generation unit 111 or the like from DC to AC.

The 11th AC/DC converter 310b includes a bidirectional AC/DC converter.

The 11th AC/DC converter 310b converts a flow of electricity of power from the 11th DC/AC inverter 310a, the commercial power source 1000, the 16th conversion device 360, and the second AC power generation device 22 from AC to DC.

The 11th AC/DC converter 310b converts a flow of electricity of power from the 11th power storage device 510 from DC to AC.

The 12th conversion device 320 includes a 12th DC/AC inverter 320a and a 12th AC/DC converter 320b.

The 12th DC/AC inverter 320a converts a flow of electricity of power from the 12th DC power generation unit 112 or the like from DC to AC.

The 12th AC/DC converter 320b includes a bidirectional AC/DC converter.

The 12th AC/DC converter 320b converts a flow of electricity of power from the 12th DC/AC inverter 320a, the commercial power source 1000, the 16th conversion device 360, and the second AC power generation device 22 from AC to DC.

The 12th AC/DC converter 320b converts a flow of electricity of power from the 12th power storage device 520 from DC to AC.

The 13th conversion device 330 includes a 13th DC/AC inverter 330a and a 13th AC/DC converter 330b.

The 13th DC/AC inverter 330a converts a flow of electricity of power from the 13th DC power generation unit 113 or the like from DC to AC.

The 13th AC/DC converter 330b includes a bidirectional AC/DC converter.

The 13th AC/DC converter 330b converts a flow of electricity of power from the 13th DC/AC inverter 330a, the commercial power source 1000, the 16th conversion device 360, and the second AC power generation device 22 from AC to DC.

The 13th AC/DC converter 330b converts a flow of electricity of power from the 13th power storage device 530 from DC to AC.

The 14th conversion device 340 includes a 14th DC/AC inverter 340a and a 14th AC/DC converter 340b.

The 14th DC/AC inverter 340a converts a flow of electricity of power from the 14th DC power generation unit 114 or the like from DC to AC.

The 14th AC/DC converter 340b includes a bidirectional AC/DC converter.

The 14th AC/DC converter 340b converts a flow of electricity of power from the 14th DC/AC inverter 340a, the commercial power source 1000, the 16th conversion device 360, and the second AC power generation device 22 from AC to DC.

The 14th AC/DC converter 340b converts a flow of electricity of power from the 14th power storage device 540 from DC to AC.

The 15th conversion device 350 includes a 15th AC/DC converter 350a.

The 15th AC/DC converter 350a converts a flow of electricity of power obtained by the first AC power generation device 21 from AC to DC.

The 16th conversion device 360 includes a 16th DC/AC inverter 360a.

The 16th DC/AC inverter 360a converts a flow of electricity of power from the electric vehicle 2000 from DC to AC.

### Power Storage Unit 50

The power storage unit 50 includes the 11th power storage device 510, the 12th power storage device 520, the 13th power storage device 530, and the 14th power storage device 540.

The 11th power storage device 510 includes a charging device and a power storage device for storing power from the 11th DC power generation unit 111 and the like.

The 12th power storage device 520 includes a charging device and a power storage device for storing power from the 12th DC power generation unit 112 and the like.

The 13th power storage device 530 includes a charging device and a power storage device for storing power from the 13th DC power generation unit 113 and the like.

The 14th power storage device 540 includes a charging device and a power storage device for storing power from the 14th DC power generation unit 114 and the like.

### Control Unit 60

The control unit 60 controls each unit of the power supply system 1.

Specifically, the control unit 60 performs on/off control or the like of the 11th switch S11 to the 31st switch S31 according to the state of each unit of the power supply system 1. Details of these controls will be described later.

A first use mode used in the description of the switch control of the control unit 60 is a use mode in which the power supply source to the first electric device 81 is set to the 11th power storage device 510.

A second use mode used in the description of the switch control of the control unit 60 is a use mode in which the power supply source to the first electric device 81 is set to the 12th power storage device 520.

The first use mode and the second use mode are switched every first switching time tt1 (for example, tt1=24 hours).

In the first use mode, when the first electric device 81 does not need to be driven, the control unit 60 turns off at least the 21st switch S21, the 22nd switch S22, and the 24th switch S24.

Further, the control unit 60 brings the 12th power storage device 520 and the control unit 60 into a conductive state via the 31st switch S31.

As a result, power supply from the 11th power storage device 510 to the load 80 and the first electric device 81 is restricted, and the 11th power storage device 510 is hardly discharged.

Further, power supply from the 12th power storage device 520 to the first electric device 81 is restricted.

Further, the control unit 60 is driven based on power supply from the 12th power storage device 520.

In the first use mode, when the first electric device 81 needs to be driven, the control unit 60 turns off at least the 21st switch S21 and the 24th switch S24, and turns on at least the 22nd switch S22.

Further, the control unit 60 brings the 22nd switch S22 and the first electric device 81 into a conductive state via the 25th switch S25.

Further, the control unit 60 brings the 12th power storage device 520 and the control unit 60 into a conductive state via the 31st switch S31.

As a result, power supply from the 11th power storage device 510 to the load 80 is restricted, and power supply from the 11th power storage device 510 to the first electric device 81 is performed.

Further, power supply from the 12th power storage device 520 to the first electric device 81 is restricted.

Further, the control unit 60 is driven based on power supply from the 12th power storage device 520.

In the second use mode, when the first electric device 81 does not need to be driven, the control unit 60 turns off at least the 22nd switch S22, the 23rd switch S23, and the 24th switch S24.

Further, the control unit 60 brings the 11th power storage device 510 and the control unit 60 into a conductive state via the 31st switch S31.

As a result, power supply from the 12th power storage device 520 to the load 80 and the first electric device 81 is restricted, and the 12th power storage device 520 is hardly discharged.

Further, power supply from the 11th power storage device 510 to the first electric device 81 is restricted.

Further, the control unit 60 is driven based on power supply from the 11th power storage device 510.

In the second use mode, when the first electric device 81 needs to be driven, the control unit 60 turns off at least the 22nd switch S22 and the 23rd switch S23, and turns on at least the 24th switch S24.

Further, the control unit 60 brings the 24th switch S24 and the first electric device 81 into a conductive state via the 25th switch S25.

Further, the control unit 60 brings the 11th power storage device 510 and the control unit 60 into a conductive state via the 31st switch S31.

As a result, power supply from the 12th power storage device 520 to the load 80 is restricted, and power supply from the 12th power storage device 520 to the first electric device 81 is performed.

Further, power supply from the 11th power storage device 510 to the first electric device 81 is restricted.

Further, the control unit 60 is driven based on power supply from the 11th power storage device 510.

A third use mode used in the description of the switch control of the control unit 60 is a use mode in which the power supply source to the second electric device 82 is set to the 13th power storage device 530.

A fourth use mode used in the description of the switch control of the control unit 60 is a use mode in which the power supply source to the second electric device 82 is set to the 14th power storage device 540.

The third use mode and the fourth use mode are switched every second switching time tt2 (for example, tt2=36 hours).

In the third use mode, when the second electric device 82 does not need to be driven, the control unit 60 turns off at least the 26th switch S26, the 27th switch S27, and the 29th switch S29.

As a result, power supply from the 13th power storage device 530 to the load 80 and the second electric device 82 is restricted, and the 13th power storage device 530 is hardly discharged.

Further, power supply from the 14th power storage device 540 to the second electric device 82 is restricted.

In the third use mode, when the second electric device 82 needs to be driven, the control unit 60 turns off at least the 26th switch S26 and the 29th switch S29, and turns on at least the 27th switch S27.

Further, the control unit 60 brings the 27th switch S27 and the second electric device 82 into a conductive state via the 30th switch S30.

As a result, power supply from the 13th power storage device 530 to the load 80 is restricted, and power supply from the 13th power storage device 530 to the second electric device 82 is performed.

Further, power supply from the 14th power storage device 540 to the second electric device 82 is restricted.

In the fourth use mode, when the second electric device 82 does not need to be driven, the control unit 60 turns off at least the 27th switch S27, the 28th switch S28, and the 29th switch S29.

As a result, power supply from the 14th power storage device 540 to the load 80 and the second electric device 82 is restricted, and the 14th power storage device 540 is hardly discharged.

Further, power supply from the 13th power storage device 530 to the second electric device 82 is restricted.

In the fourth use mode, when the second electric device 82 needs to be driven, the control unit 60 turns off at least the 27th switch S27 and the 28th switch S28, and turns on at least the 29th switch S29.

Further, the control unit 60 brings the 29th switch S29 and the second electric device 82 into a conductive state via the 30th switch S30.

As a result, power supply from the 14th power storage device 540 to the load 80 is restricted, and power supply from the 14th power storage device 540 to the second electric device 82 is performed.

Further, power supply from the 13th power storage device 530 to the second electric device 82 is restricted.

### 11th Switch S11 to 31st Switch S31

The 11th switch S11 to the 24th switch S24 and the 26th switch S26 to the 29th switch S29 are switched on or off such that an energized state and a non-energized state of each unit are switched.

The 25th switch S25 switches between an energized state of a member (for example, the 22nd switch S22) connected to an a-th contact (NO terminal) and an energized state of a member (for example, the 24th switch S24) connected to a b-th contact (NC terminal).

The 30th switch S30 switches between an energized state of a member (for example, the 27th switch S27) connected to the a-th contact and an energized state of a member (for example, the 29th switch S29) connected to the b-th contact.

The 31st switch S31 switches between an energized state of a member (for example, the 11th power storage device 510) connected to the a-th contact and an energized state of a member (for example, the 12th power storage device 520) connected to the b-th contact.

The 11th switch S11 is provided on the power line from the 11th DC power generation unit 111 between the 11th DC power generation unit 111 and an 11th power line L11.

When power from the 11th DC power generation unit 111 is supplied to any one of the 11th power storage device 510 to the 14th power storage device 540, the 11th switch S11 is turned on.

The 11th power line L11 is a DC power line that connects the 11th DC power generation unit 111, the 12th DC power generation unit 112, the 13th DC power generation unit 113, the 14th DC power generation unit 114, and the first AC power generation device 21.

The 12th switch S12 is provided on the power line from the 12th DC power generation unit 112 between the 12th DC power generation unit 112 and the 11th power line L11.

When power from the 12th DC power generation unit 112 is supplied to any one of the 11th power storage device 510 to the 14th power storage device 540, the 12th switch S12 is turned on.

The 13th switch S13 is provided on the power line from the 13th DC power generation unit 113 between the 13th DC power generation unit 113 and the 11th power line L11.

When power from the 13th DC power generation unit 113 is supplied to any one of the 11th power storage device 510 to the 14th power storage device 540, the 13th switch S13 is turned on.

The 14th switch S14 is provided on the power line from the 13th DC power generation unit 114 between the 14th DC power generation unit 114 and the 11th power line L11.

When power from the 14th DC power generation unit 114 is supplied to any one of the 11th power storage device 510 to the 14th power storage device 540, the 14th switch S14 is turned on.

The 15th switch S15 is provided on the power line from the 11th DC/AC inverter 310a between the 11th DC/AC inverter 310a and the 11th power line L11.

When power from at least one of the 11th DC power generation unit 111 to the 14th DC power generation unit 114 and the first AC power generation device 21 is supplied to the 11th power storage device 510, the 15th switch S15 is turned on.

The 16th switch S16 is provided on the power line from the 12th DC/AC inverter 320a between the 12th DC/AC inverter 320a and the 11th power line L11.

When power from at least one of the 11th DC power generation unit 111 to the 14th DC power generation unit 114 and the first AC power generation device 21 is supplied to the 12th power storage device 520, the 16th switch S16 is turned on.

The 17th switch S17 is provided on the power line from the 13th DC/AC inverter 330a between the 13th DC/AC inverter 330a and the 11th power line L11.

When power from at least one of the 11th DC power generation unit 111 to the 14th DC power generation unit 114 and the first AC power generation device 21 is supplied to the 13th power storage device 530, the 17th switch S17 is turned on.

The 18th switch S18 is provided on the power line from the 14th DC/AC inverter 340a between the 14th DC/AC inverter 340a and the 11th power line L11.

When power from at least one of the 11th DC power generation unit 111 to the 14th DC power generation unit 114 and the first AC power generation device 21 is supplied to the 14th power storage device 540, the 18th switch S18 is turned on.

The 19th switch S19 is provided on the power line (the 12th power line L12) from the commercial power source 1000 between the commercial power source 1000 and the power line from the 16th conversion device 360.

When power from commercial power source 1000 is supplied to any one of the 11th power storage device 510 to the 14th power storage device 540 and the load 80, the 19th switch S19 is turned on.

The 20th switch S20 is provided on the power line from the second AC power generation device 22 between the second AC power generation device 22 and the 12th power line L12.

When power from the second AC power generation device 22 is supplied to any one of the 11th power storage device 510 to the 14th power storage device 540 and the load 80, the 20th switch S20 is turned on.

The 21st switch S21 is provided between the 11th AC/DC converter 310b and the load 80.

When power from the 11th power storage device 510 is supplied to the load 80, the 21st switch S21 is turned on.

The 22nd switch S22 is provided between the 11th AC/DC converter 310b and the 25th switch S25.

When power from the 11th power storage device 510 is supplied to the first electric device 81, the 22nd switch S22 is turned on.

The 23rd switch S23 is provided between the 12th AC/DC converter 320b and the load 80.

When power from the 12th power storage device 520 is supplied to the load 80, the 23rd switch S23 is turned on.

The 24th switch S24 is provided between the 12th AC/DC converter 320b and the 25th switch S25.

When power from the 12th power storage device 520 is supplied to the first electric device 81, the 24th switch S24 is turned on.

The a-th contact of the 25th switch S25 is connected to the 22nd switch S22, the b-th contact of the 25th switch S25 is connected to the 24th switch S24, and the common terminal of the 25th switch S25 is connected to the first electric device 81.

However, the b-th contact of the 25th switch S25 may be connected to the 22nd switch S22, and the a-th contact of the 25th switch S25 may be connected to the 24th switch S24.

The 26th switch S26 is provided between the 13th AC/DC converter 330b and the load 80.

When power from the 13th power storage device 530 is supplied to the load 80, the 26th switch S26 is turned on.

The 27th switch S27 is provided between the 13th AC/DC converter 330b and the 30th switch S30.

When power from the 13th power storage device 530 is supplied to the second electric device 82, the 27th switch S27 is turned on.

The 28th switch S28 is provided between the 14th AC/DC converter 340b and the load 80.

When power from the 14th power storage device 540 is supplied to the load 80, the 28th switch S28 is turned on.

The 29th switch S29 is provided between the 14th AC/DC converter 340b and the 30th switch S30.

When power from the 14th power storage device 540 is supplied to the second electric device 82, the 29th switch S29 is turned on.

The a-th contact of the 30th switch S30 is connected to the 27th switch S27, the b-th contact of the 30th switch S30 is connected to the 29th switch S29, and the common terminal of the 30th switch S30 is connected to the second electric device 82.

However, the b-th contact of the 30th switch S30 may be connected to the 27th switch S27, and the a-th contact of the 30th switch S30 may be connected to the 29th switch S29.

The a-th contact of the 31st switch S31 is connected to the 11th power storage device 510, the b-th contact of the 31st switch S31 is connected to the 12th power storage device 520, and the common terminal of the 31st switch S31 is connected to the control unit 60.

However, the b-th contact of the 31st switch S31 may be connected to the 11th power storage device 510, and the a-th contact of the 31st switch S31 may be connected to the 12th power storage device 520.

In the second embodiment, a description has been given as to an example in which the 31st switch S31 is configured in a double-throw type, and the power source for supplying power to the control unit 60 is switched between the 11th power storage device 510 and the 12th power storage device 520.

However, the power source for power to the control unit 60 may be switched between the 13th power storage device 530 and the 14th power storage device 540.

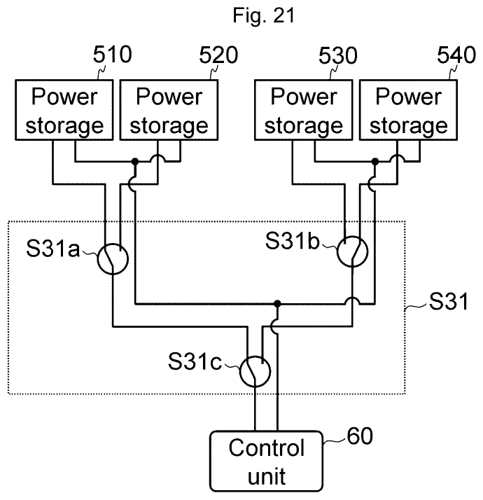

Further, the power source for power to the control unit 60 may be switched among the 11th power storage device 510, the 12th power storage device 520, the 13th power storage device 530, and the 14th power storage device 540 (refer to FIG. 21).

In this case, the 31st switch S31 is formed by substantially three-throw type.

For example, the 31st switch S31 includes a 311th switch S31a, a 312th switch S31b, and a 313th switch S31c.

The 311th switch S31a is used for switching to either the 11th power storage device 510 or the 12th power storage device 520.

The 312th switch S31b is used for switching to either the 13th power storage device 530 or the 14th power storage device 540.

The 313th switch S31c is used for switching to either one of the 11th power storage device 510 and the 12th power storage device 520 or one of the 13th power storage device 530 and the 14th power storage device 540.

In this case as well, switch control is performed so that one of the 11th power storage device 510 and the 12th power storage device 520, which is set as the power supply source to the first electric device 81, and one of the 13th power storage device 530 and the 14th power storage device 540, which is set as the power supply source to the second electric device 82, are not used as the power supply source to the control unit 60.

That is, in the first use mode and the third use mode, power is supplied from either the 12th power storage device 520 or the 14th power storage device 540 to the control unit 60.

In the first use mode and the fourth use mode, power is supplied from either the 12th power storage device 520 or the 13th power storage device 530 to the control unit 60.

Additionally, in the second use mode and the third use mode, power is supplied from either the 11th power storage device 510 or the 14th power storage device 540 to the control unit 60.

In the second use mode and the fourth use mode, power is supplied from either the 11th power storage device 510 or the 13th power storage device 530 to the control unit 60.

As a result, the power storage device necessary for supplying the power necessary for driving the first electric device 81 for the first time Ti1 and the power storage device necessary for supplying the power necessary for driving the second electric device 82 for the second time Ti2 are preserved, and the power supply of the control unit 60 can be performed using other power storage devices.

The power from the 11th DC power generation unit 111 is supplied to the 11th power storage device 510 via the 11th switch S11, the 15th switch S15, the 11th DC/AC inverter 310a, and the 11th AC/DC converter 310b.

The power from the 12th DC power generation unit 112 is supplied to the 11th power storage device 510 via the 12th switch S12, the 15th switch S15, the 11th DC/AC inverter 310a, and the 11th AC/DC converter 310b.

The power from the 13th DC power generation unit 113 is supplied to the 11th power storage device 510 via the 13th switch S13, the 15th switch S15, the 11th DC/AC inverter 310a, and the 11th AC/DC converter 310b.

The power from the 14th DC power generation unit 114 is supplied to the 11th power storage device 510 via the 14th switch S14, the 15th switch S15, the 11th DC/AC inverter 310a, and the 11th AC/DC converter 310b.

The power from the first AC power generation device 21 is supplied to the 11th power storage device 510 via the 15th AC/DC converter 350a, the 15th switch S15, the 11th DC/AC inverter 310a, and the 11th AC/DC converter 310b.

The power from the commercial power source 1000 is supplied to the 11th power storage device 510 via the 19th switch S19 and the 11th AC/DC converter 310b.

The power from the electric vehicle 2000 is supplied to the 11th power storage device 510 via the 16th DC/AC inverter 360a and the 11th AC/DC converter 310b.

The power from the second AC power generation device 22 is supplied to the 11th power storage device 510 via the 20th switch S20 and the 11th AC/DC converter 310b.

The power from the 11th DC power generation unit 111 is supplied to the 12th power storage device 520 via the 11th switch S11, the 16th switch S16, the 12th DC/AC inverter 320a, and the 12th AC/DC converter 320b.

The power from the 12th DC power generation unit 112 is supplied to the 12th power storage device 520 via the 12th switch S12, the 16th switch S16, the 12th DC/AC inverter 320a, and the 12th AC/DC converter 320b.

The power from the 13th DC power generation unit 113 is supplied to the 12th power storage device 520 via the 13th switch S13, the 16th switch S16, the 12th DC/AC inverter 320a, and the 12th AC/DC converter 320b.

The power from the 14th DC power generation unit 114 is supplied to the 12th power storage device 520 via the 14th switch S14, the 16th switch S16, the 12th DC/AC inverter 320a, and the 12th AC/DC converter 320b.

The power from the first AC power generation device 21 is supplied to the 12th power storage device 520 via the 15th AC/DC converter 350a, the 16th switch S16, the 12th DC/AC inverter 320a, and the 12th AC/DC converter 320b.

The power from the commercial power source 1000 is supplied to the 12th power storage device 520 via the 19th switch S19 and the 12th AC/DC converter 320b.

The power from the electric vehicle 2000 is supplied to the 12th power storage device 520 via the 16th DC/AC inverter 360a and the 12th AC/DC converter 320b.

The power from the second AC power generation device 22 is supplied to the 12th power storage device 520 via the 20th switch S20 and the 12th AC/DC converter 320b.

The power from the 11th DC power generation unit 111 is supplied to the 13th power storage device 530 via the 11th switch S11, the 17th switch S17, the 13th DC/AC inverter 330a, and the 13th AC/DC converter 330b.

The power from the 12th DC power generation unit 112 is supplied to the 13th power storage device 530 via the 12th switch S12, the 17th switch S17, the 13th DC/AC inverter 330a, and the 13th AC/DC converter 330b.

The power from the 13th DC power generation unit 113 is supplied to the 13th power storage device 530 via the 13th switch S13, the 17th switch S17, the 13th DC/AC inverter 330a, and the 13th AC/DC converter 330b.

The power from the 14th DC power generation unit 114 is supplied to the 13th power storage device 530 via the 14th switch S14, the 17th switch S17, the 13th DC/AC inverter 330a, and the 13th AC/DC converter 330b.

The power from the first AC power generation device 21 is supplied to the 13th power storage device 530 via the 15th AC/DC converter 350a, the 17th switch S17, the 13th DC/AC inverter 330a, and the 13th AC/DC converter 330b.

The power from the commercial power source 1000 is supplied to the 13th power storage device 530 via the 19th switch S19 and the 13th AC/DC converter 330b.

The power from the electric vehicle 2000 is supplied to the 13th power storage device 530 via the 16th DC/AC inverter 360a and the 13th AC/DC converter 330b.

The power from the second AC power generation device 22 is supplied to the 13th power storage device 530 via the 20th switch S20 and the 13th AC/DC converter 330b.

The power from the 11th DC power generation unit 111 is supplied to the 14th power storage device 540 via the 11th switch S11, the 18th switch S18, the 14th DC/AC inverter 340a, and the 14th AC/DC converter 340b.

The power from the 12th DC power generation unit 112 is supplied to the 14th power storage device 540 via the 12th switch S12, the 18th switch S18, the 14th DC/AC inverter 340a, and the 14th AC/DC converter 340b.

The power from the 13th DC power generation unit 113 is supplied to the 14th power storage device 540 via the 13th switch S13, the 18th switch S18, the 14th DC/AC inverter 340a, and the 14th AC/DC converter 340b.

The power from the 14th DC power generation unit 114 is supplied to the 14th power storage device 540 via the 14th switch S14, the 18th switch S18, the 14th DC/AC inverter 340a, and the 14th AC/DC converter 340b.

The power from the first AC power generation device 21 is supplied to the 14th power storage device 540 via the 15th AC/DC converter 350a, the 18th switch S18, the 14th DC/AC inverter 340a, and the 14th AC/DC converter 340b.

The power from the commercial power source 1000 is supplied to the 14th power storage device 540 via the 19th switch S19 and the 14th AC/DC converter 340b.

The power from the electric vehicle 2000 is supplied to the 14th power storage device 540 via the 16th DC/AC inverter 360a and the 14th AC/DC converter 340b.

The power from the second AC power generation device 22 is supplied to the 14th power storage device 540 via the 20th switch S20 and the 14th AC/DC converter 340b.

The power from the 11th power storage device 510 is supplied to the control unit 60 via the 31st switch S31.

The power from the 11th power storage device 510 is supplied to the load 80 via the 11th AC/DC converter 310b and the 21st switch S21.

The power from the 11th power storage device 510 is supplied to the first electric device 81 via the 11th AC/DC converter 310b, the 22nd switch S22, and the 25th switch S25.

The power from the 12th power storage device 520 is supplied to the control unit 60 via the 31st switch S31.

The power from the 12th power storage device 520 is supplied to the load 80 via the 12th AC/DC converter 320b and the 23rd switch S23.

The power from the 12th power storage device 520 is supplied to the first electric device 81 via the 12th AC/DC converter 320b, the 24th switch S24, and the 25th switch S25.

The power from the 13th power storage device 530 is supplied to the load 80 via the 13th AC/DC converter 330b and the 26th switch S26.

The power from the 13th power storage device 530 is supplied to the second electric device 82 via the 13th AC/DC converter 330b, the 27th switch S27, and the 30th switch S30.

The power from the 14th power storage device 540 is supplied to the load 80 via the 14th AC/DC converter 340b and the 28th switch S28.

The power from the 14th power storage device 540 is supplied to the second electric device 82 via the 14th AC/DC converter 340b, the 29th switch S29, and the 30th switch S30.

### Application Example of Releasing Power Supply Restriction

In the second embodiment, a description has been given as to an example in which the power supply from the power storage device (the 11th power storage device 510 or the 12th power storage device 520) set as the power supply source to the first electric device 81 to the load 80 is restricted.

However, when there is a margin in the state of charging of said power storage device, that is, when more power than power required to drive the first electric device 81 for the first time Ti1 is stored in said power storage device, surplus power may be used for supplying to the load 80.

Further, a description has been given as to an example in which the power supply from the power storage device (the 13th power storage device 530 or the 14th power storage device 540) set as the power supply source to the second electric device 82 to the load 80 is restricted.

However, when there is a margin in the state of charging of said power storage device, that is, when more power than power required to drive the second electric device 82 for the second time Ti2 is stored in said power storage device, surplus power may be used for supplying to the load 80.

Specifically, in the first use mode, when the 11th power storage device 510 can drive the first electric device 81 for a time longer than the first time Ti1, the 21st switch S21 is turned on until the first condition is satisfied, and restriction of the power supply from the 11th power storage device 510 to the load 80 is released.

Specifically, in the second use mode, when the 12th power storage device 520 can drive the first electric device 81 for a time longer than the first time Ti1, the 23rd switch S23 is turned on until the first condition is satisfied, and restriction of the power supply from the 12th power storage device 520 to the load 80 is released.

Further, in the third use mode, when the 13th power storage device 530 can drive the second electric device 82 for a time longer than the second time Ti2, the 26th switch S26 is turned on until the second condition is satisfied, and restriction of the power supply from the 13th power storage device 530 to the load 80 is released.

Further, in the fourth use mode, when the 14th power storage device 540 can drive the second electric device 82 for a time longer than the second time Ti2, the 28th switch S28 is turned on until the second condition is satisfied, and restriction of the power supply from the 14th power storage device 540 to the load 80 is released.

Accordingly, it is possible to supply surplus power to the other load 80 while securing power that can be supplied to the first electric device 81 and the second electric device 82.

### Application to Load Test

The power supply device 2 of the second embodiment may be used for a load test of the connected power generation device (for example, the second AC power generation device 22).

In this case, the conversion unit 30 and the power storage unit 50 are used as a load (resistance) for a load test.

Specifically, in the first use mode and the third use mode, the load test of the power generation device connected to at least one of the 12th power storage device 520 and the 14th power storage device 540 is performed using at least one of the 12th power storage device 520 and the 14th power storage device 540.

In the first use mode and the fourth use mode, the load test of the power generation device connected to at least one of the 12th power storage device 520 and the 13th power storage device 530 is performed using at least one of the 12th power storage device 520 and the 13th power storage device 530.

In the second use mode and the third use mode, the load test of the power generation device connected to at least one of the 11th power storage device 510 and the 14th power storage device 540 is performed using at least one of the 11th power storage device 510 and the 14th power storage device 540.

In the second use mode and the fourth use mode, the load test of the power generation device connected to at least one of the 11th power storage device 510 and the 13th power storage device 530 is performed using at least one of the 11th power storage device 510 and the 13th power storage device 530.

As a result, the load test can be performed using the power storage device in which almost no power is stored.

### Application of Number of Power Storage Devices and Number of Electric Devices

In the second embodiment, a description has been given as to an example in which two electric devices (the first electric device 81 and the second electric device 82) are provided separately from the load 80, and power is supplied from two power storage devices to the respective electric devices.

However, the number of electric devices is not limited to two, and may be one or three or more.

The number of power storage devices that supply power to one electric device is not limited to two, and may be three or more.

Although some embodiments of the present invention have been described, these embodiments have been presented as examples, and are not intended to limit the scope of the invention. These embodiments can be implemented in various other forms, and various omissions, substitutions, and changes can be made without departing from the gist of the invention. These embodiments and modifications thereof are included in the scope and gist of the invention and are included in the invention described in the claims and the scope equivalent thereto.

### Reference Signs List

1 power supply system
2 power supply device
10 DC power supply unit
11 first DC power generation device
111 11th DC power generation unit
112 12th DC power generation unit
113 13th DC power generation unit
114 14th DC power generation unit
12 second DC power generation device
20 AC power supply unit
21 first AC power generation device
22 second AC power generation device
30 conversion unit
31 first conversion device
31a first DC/DC converter
31b second DC/DC converter
31c first DC/AC inverter
32 second conversion device
32a third DC/DC converter (step-up/step-down DC/DC converter)
32b fourth DC/DC converter (bidirectional DC/DC converter)
32c AC/DC converter (bidirectional AC/DC converter)
33 third conversion device
33a fifth DC/DC converter (step-up/step-down DC/DC converter)
310 11th conversion device
310a11 th DC/AC inverter
310b11 th AC/DC converter
320 12th conversion device
320a12 th DC/AC inverter
320b12 th AC/DC converter
330 13th conversion device
330a13 th DC/AC inverter
330b13 th AC/DC converter
340 14th conversion device
340a14 th DC/AC inverter
340b14 th AC/DC converter
350 15th conversion device
350a15 th AC/DC converter
360 16th conversion device
360a16 th DC/AC inverter
40 switching unit
41a to 41e first port to fifth port
43a to 43f first internal switch to sixth internal switch
45a to 45f first internal power line to sixth internal power line
50 power storage unit
51 first power storage device
52 second power storage device
510 11th power storage device
520 12th power storage device
530 13th power storage device
540 14th power storage device
60 control unit
70 hydrogen supply unit
71 hydrogen generation unit
72 water supply unit
80 load
81 first electric device
82 second electric device
1000 commercial power source
2000 electric vehicle
S1 to S5 first switch to fifth switch
S11 to S31 11th switch to 31st switch
B1 to B3 first valve to third valve
c1 connection point between first power line and second power line
c2 connection point between first power line and third power line
c3 connection point between second power line and fourth power line
c4 connection point between sixth power line and seventh power line
c5 connection point between first power line and fourth power line
L1 to L7 first power line to seventh power line
L11 11th power line
L12 12th power line
P11 power supplied from first DC power generation device
P21 power supplied from first AC power generation device
R1 charging rate of first power storage device
R2 charging rate of second power storage device
Rh hydrogen filling rate of tank of hydrogen generation unit
S1 to S5 first switch to fifth switch
T1 hydrogen supply pipe
T2 oxygen supply pipe
T3 first electrolytic solution supply pipe
T4 second electrolytic solution supply pipe
Thp1 first power threshold
Thp2 second power threshold
Thr1 first charging rate threshold
Thr2 second charging rate threshold
Thr3 third charging rate threshold
Thr4 fourth charging rate threshold
Thrh hydrogen filling rate threshold
Ti1 first time
Ti2 second time
tt1 first switching time
tt2 second switching time

1. A power supply device that supplies power to an external load and a first electric device different from the load, the power supply device comprising:
a power storage unit including a first power storage device and a second power storage device; and
a first switch used, when a first condition is satisfied, to switch a power supply source to the first electric device between the first power storage device and the second power storage device in order to drive the first electric device for at least a first time, wherein
the first power storage device is capable of supplying the power to the load and the first electric device,
the second power storage device is capable of supplying the power to the load and the first electric device,
in a first use mode in which the power supply source to the first electric device is set to the first power storage device, until the first condition is satisfied, power supply from the first power storage device to the load and the first electric device and power supply from the second power storage device to the first electric device are restricted,
in the first use mode, when the first condition is satisfied, the power supply from the first power storage device to the load is restricted, the power supply from the second power storage device to the first electric device is restricted, and the power supply from the first power storage device to the first electric device is performed,
in a second use mode in which the power supply source to the first electric device is set to the second power storage device, until the first condition is satisfied, power supply from the second power storage device to the load and the first electric device and power supply from the first power storage device to the first electric device are restricted, and
in the second use mode, when the first condition is satisfied, the power supply from the second power storage device to the load is restricted, the power supply from the first power storage device to the first electric device is restricted, and the power supply from the second power storage device to the first electric device is performed.

2. The power supply device according to claim 1, wherein
in the first use mode, when the first power storage device is capable of driving the first electric device for a time longer than the first time, restriction of the power supply from the first power storage device to the load is released until the first condition is satisfied, and
in the second use mode, when the second power storage device is capable of driving the first electric device for a time longer than the first time, restriction of the power supply from the second power storage device to the load is released until the first condition is satisfied.

3. The power supply device according to claim 1, wherein
the power supply device supplies the power to the load, the first electric device, and a second electric device different from the load and the first electric device,
the power storage unit includes a third power storage device and a fourth power storage device,
the power supply device includes a second switch used, when a second condition is satisfied, to switch a power supply source to the second electric device between the third power storage device and the fourth power storage device in order to drive the second electric device for at least a second time,
the third power storage device is capable of supplying the power to the load and the second electric device,
the fourth power storage device is capable of supplying the power to the load and the second electric device,
in a third use mode in which the power supply source to the second electric device is set to the third power storage device, until the second condition is satisfied, power supply from the third power storage device to the load and the second electric device and power supply from the fourth storage device to the second electric device are restricted,
in the third use mode, when the second condition is satisfied, the power supply from the third power storage device to the load is restricted, the power supply from the fourth power storage device to the second electric device is restricted, and the power supply from the third power storage device to the second electric device is performed,
in a fourth use mode in which the power supply source to the second electric device is set to the fourth power storage device, until the second condition is satisfied, power supply from the fourth power storage device to the load and the second electric device and power supply from the third power storage device to the second electric device are restricted, and
in the fourth use mode, when the second condition is satisfied, the power supply from the fourth power storage device to the load is restricted, the power supply from the third power storage device to the second electric device is restricted, and the power supply from the fourth power storage device to the second electric device is performed.

4. The power supply device according to claim 3, wherein
in the first use mode, when the first power storage device is capable of driving the first electric device for a time longer than the first time, restriction of the power supply from the first power storage device to the load is released until the first condition is satisfied,
in the second use mode, when the second power storage device is capable of driving the first electric device for a time longer than the first time, restriction of the power supply from the second power storage device to the load is released until the first condition is satisfied,
in the third use mode, when the third power storage device is capable of driving the second electric device for a time longer than the second time, restriction of the power supply from the third power storage device to the load is released until the second condition is satisfied, and
in the fourth use mode, when the fourth power storage device is capable of driving the second electric device for a time longer than the second time, restriction of the power supply from the fourth power storage device to the load is released until the second condition is satisfied.

5. The power supply device according to claim 3, wherein
the power supply device includes a control unit configured to control at least the first switch and the second switch,
the power is supplied from either the second power storage device or the fourth power storage device to the control unit in the first use mode and in the third use mode,
the power is supplied from either the second power storage device or the third power storage device to the control unit in the first use mode and in the fourth use mode,
the power is supplied from either the first power storage device or the fourth power storage device to the control unit in the second use mode and in the third use mode, and
the power is supplied from either the first power storage device or the third power storage device to the control unit in the second use mode and the fourth use mode.

6. The power supply device according to claim 3, wherein
in the first use mode and in the third use mode, a load test of a power generation device connected to at least one of the second power storage device and the fourth power storage device is performed using at least one of the second power storage device and the fourth power storage device,
in the first use mode and in the fourth use mode, a load test of a power generation device connected to at least one of the second power storage device and the third power storage device is performed using at least one of the second power storage device and the third power storage device,
in the second use mode and in the third use mode, a load test of a power generation device connected to at least one of the first power storage device and the fourth power storage device is performed using at least one of the first power storage device and the fourth power storage device, and
in the second use mode and in the fourth use mode, a load test of a power generation device connected to at least one of the first power storage device and the third power storage device is performed using at least one of the first power storage device and the third power storage device.
